(19) United States
(12) Patent Application Publication
(10) Pub. No.: US 2026/0270624 A1
(43) Pub. Date: Sep. 10, 2026

(54) SOUND PROCESSING DEVICE AND SOUND PROCESSING SYSTEM

(71) Applicant: SONY GROUP CORPORATION, TOKYO (JP)

(72) Inventors: MASAKI KAMATA, TOKYO (JP); KOHEI ASADA, TOKYO (JP); YUSHI YAMABE, TOKYO (JP); NAOKI SHINMEN, TOKYO (JP); NATSUKO MAEDA, TOKYO (JP)

(21) Appl. No.: 19/166,613

(22) PCT Filed: Dec. 26, 2023
(86) PCT No.: PCT/JP2023/046581

§ 371 Date: Sep. 18, 2025

(30) Foreign Application Priority Data
Mar. 31, 2023 (JP) 2023-059483

(51) Int. Cl. H04R 25/00

(52) U.S. Cl. CPC H04R 25/402; H04R 25/405; H04R 25/505; H04R 2430/01

(57) ABSTRACT

A sound processing device is provided, which includes a first sound collection unit configured to acquire a sound; an acoustic metamaterial attached to the first sound collection unit; and an output unit configured to output the sound acquired by the first sound collection unit. The acoustic metamaterial gives a predetermined characteristic to the sound according to a direction of arrival of the sound, and the first sound collection unit acquires the sound having the predetermined characteristic.

### TECHNICAL FIELD

The present disclosure relates to a sound processing device and a sound processing system.

### BACKGROUND ART

A hearing aid (sound processing device) is widely used as a device for improving user's hearing. For example, the hearing aid includes a microphone, a receiver, and the like, and is worn on a part of the body of the user. The hearing aid collects sound around the user, performs processing such as amplification on the collected sound according to the auditory characteristics of the user, and outputs the sound to the user.

### CITATION LIST

### Patent Literature

[PTL 1] Japanese Laid-open Patent Publication No. 2005-349155

### Non-Patent Literature

[NPL 1] Yangmer, Single-sensor multispeaker listening with acoustic metamaterials, PNAS Aug. 25, 2015 Vol. 112 no. 34

### SUMMARY OF INVENTION

### Technical Problem

When the user hears the surrounding sound through the hearing aid (sound processing device), the user can clearly hear the sound with the hearing aid, but it is difficult for the user to understand from which direction (direction of arrival) the sound is heard. Therefore, for example, in the technique disclosed in PTL 1, the sound pressure of sound is compared for each direction of arrival, and an actuator corresponding to a direction of arrival of sound having a large sound pressure is vibrated to present the direction of arrival of the sound to a user. However, in the technique disclosed in PTL 1, since a large number of microphones, actuators, and the like are used, it is difficult to implement the technique in a small hearing aid.

Therefore, the present disclosure proposes a sound processing device and a sound processing system that can be implemented even with a small device and can output a sound so that a user can recognize a direction of arrival of the sound.

### Solution to Problem

According to the present disclosure, there is provided a sound processing device including: a first sound collection unit configured to acquire a sound; an acoustic metamaterial attached to the first sound collection unit; and an output unit configured to output the sound acquired by the first sound collection unit. In the sound processing device, the acoustic metamaterial gives a predetermined characteristic to the sound according to a direction of arrival of the sound, and the first sound collection unit acquires the sound having the predetermined characteristic.

Furthermore, according to the present disclosure, there is provided a sound processing system including: a sound processing device; and an information processing terminal used by a user.

In the sound processing system, the sound processing device and the information processing terminal can communicate with each other, and the sound processing device includes: a first sound collection unit configured to acquire a sound; an acoustic metamaterial attached to the first sound collection unit; and an output unit configured to output the sound acquired by the first sound collection unit. In the sound processing device, the acoustic metamaterial gives a predetermined characteristic to the sound according to a direction of arrival of the sound, and the first sound collection unit acquires the sound having the predetermined characteristic.

### BRIEF DESCRIPTION OF DRAWINGS

FIG. 1 is a diagram illustrating a schematic configuration of a hearing aid system 1 according to an embodiment of the present disclosure.

FIG. 2 is a block diagram for explaining functional blocks of a hearing aid 2 and a charger 3 according to the embodiment of the present disclosure.

FIG. 3 is a block diagram for explaining functional blocks of an information processing terminal 40 according to the embodiment of the present disclosure.

FIG. 4 is a diagram illustrating an example of a configuration of a behind-the-ear hearing aid 100 according to a first embodiment of the present disclosure.

FIG. 5 is a cross-sectional view illustrating a state in which a receiver 101 of the behind-the-ear hearing aid 100 according to the first embodiment of the present disclosure is inserted into an ear canal of a user.

FIG. 6 is a diagram illustrating a configuration example of an in-the-ear hearing aid 500 according to the first embodiment of the present disclosure.

FIG. 7 is a cross-sectional view illustrating a state in which the in-the-ear hearing aid 500 according to the first embodiment of the present disclosure is inserted into the ear canal of the user.

FIG. 8 is a diagram illustrating a configuration example of a neck band type hearing aid 600 according to the first embodiment of the present disclosure.

FIG. 9 is an explanatory diagram for explaining a hearing aid 800 to which a hearing aid component according to the first embodiment of the present disclosure is attached.

FIG. 10 is an explanatory diagram (part 1) for explaining a resonating body according to the first embodiment of the present disclosure.

FIG. 11 is an explanatory diagram (part 2) for explaining the resonating body according to the first embodiment of the present disclosure.

FIG. 12 is an explanatory diagram (part 3) for explaining the resonating body according to the first embodiment of the present disclosure.

FIG. 13 is an explanatory diagram (part 4) for explaining the resonating body according to the first embodiment of the present disclosure.

FIG. 14 is a block diagram for explaining functional blocks of a processing unit 870 according to the first embodiment of the present disclosure.

FIG. 15 is a block diagram for explaining functional blocks of a processing unit 870a according to a modification of the first embodiment of the present disclosure.

FIG. 16 is a block diagram for explaining functional blocks of a processing unit 870b according to a second embodiment of the present disclosure.

FIG. 17 is an explanatory diagram for explaining a direction estimation unit 876 according to the second embodiment of the present disclosure.

FIG. 18 is an explanatory diagram for explaining a training method 1 according to a third embodiment of the present disclosure.

FIG. 19 is an explanatory diagram for explaining a training method 2 according to the third embodiment of the present disclosure.

FIG. 20 is a diagram illustrating a schematic configuration of a hearing aid system la according to a modification of the embodiment of the present disclosure.

FIG. 21 is a block diagram for explaining functional blocks of a server 90 according to the modification of the embodiment of the present disclosure.

FIG. 22 is a diagram illustrating an example of use of data.

FIG. 23 is a diagram illustrating an example of data.

FIG. 24 is a diagram illustrating an example of cooperation with another device.

FIG. 25 is a diagram illustrating an example of changes of use.

### DESCRIPTION OF EMBODIMENTS

Hereinafter, preferred embodiments of the present disclosure will be described in detail with reference to the accompanying drawings. Note that, in the present specification and the drawings, components having substantially the same functional configurations are denoted by the same reference signs, and redundant description is omitted. In addition, in the present specification and the drawings, a plurality of components having substantially the same functional configuration or similar functional configurations may be distinguished by attaching different alphabets after the same reference sign. However, in a case where it is not particularly necessary to distinguish each of a plurality of components having substantially the same functional configuration or similar functional configurations, only the same reference sign is attached.

In addition, the drawings referred to in the following description are drawings for explaining an embodiment of the present disclosure and promoting understanding of the embodiment of the present disclosure, and shapes, dimensions, ratios, and the like illustrated in the drawings may be different from actual ones for the sake of clarity. Furthermore, devices illustrated in the drawings can be appropriately modified in design in consideration of the following description and known techniques.

Note that the description will be given in the following order.
1. Outline of Hearing Aid System
2. Background
3. First Embodiment
3.1 External Configuration of Hearing Aid
3.2 Hearing Aid to which Hearing Aid Component is Attached
3.3 Resonating Bodies
3.4 Processing Unit
3.5 Variation of Processing Unit
3.6 Usage
4. Second Embodiment
5. Third Embodiment
5.1 Training Method 1
5.2 Training Method 2
6. Summary
7. Variation of Hearing Aid System
8. Example of Use of Data
9. Example of Cooperation with Another Device
10. Example of Changes of Use
11. Supplement

### 1. Outline of Hearing Aid System

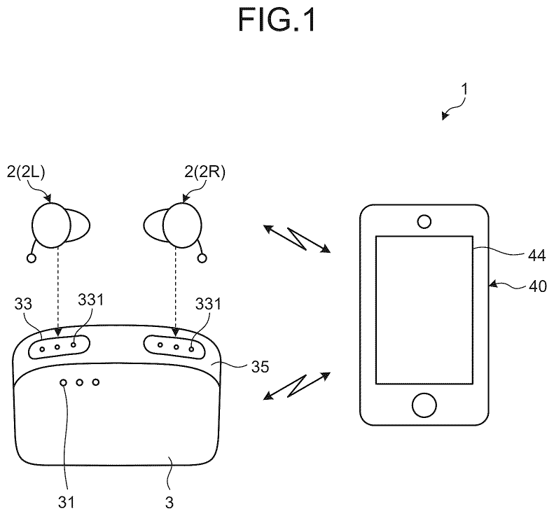

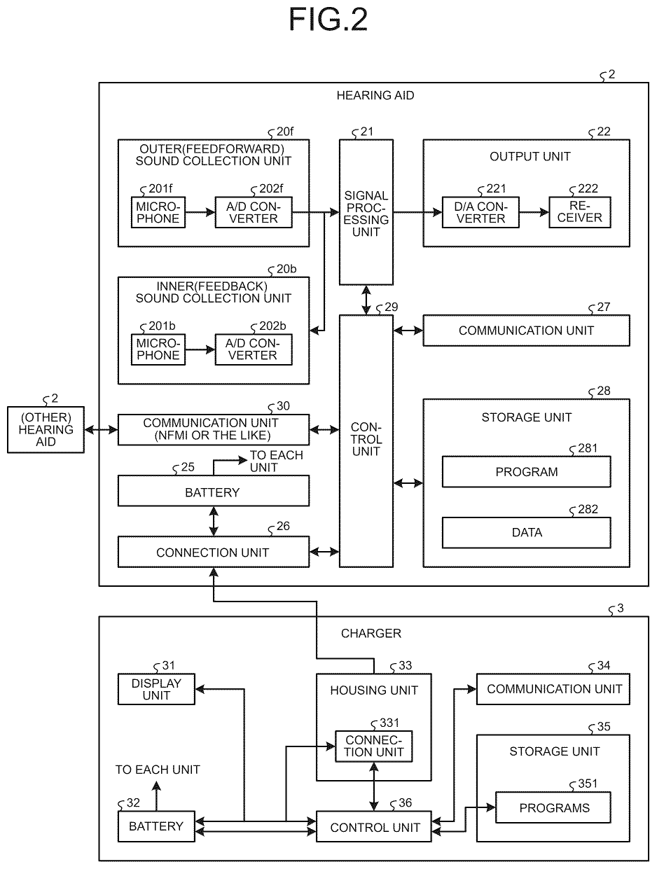

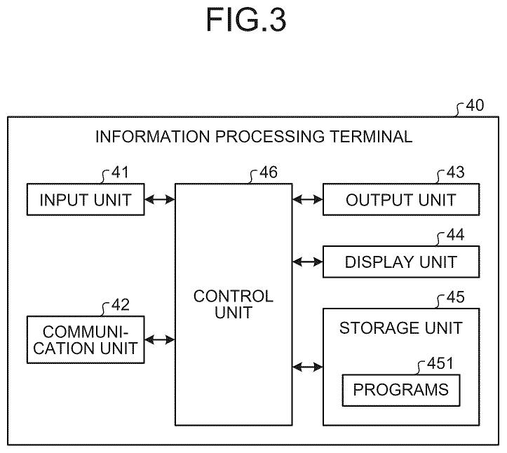

First, an outline of a hearing aid system 1 according to an embodiment of the present disclosure will be described with reference to FIGS. 1 to 3. FIG. 1 is a diagram illustrating a schematic configuration of the hearing aid system 1 according to the embodiment of the present disclosure, and FIG. 2 is a block diagram for explaining functional blocks of a hearing aid 2 and a charger 3 according to the embodiment of the present disclosure. In addition, FIG. 3 is a block diagram for explaining functional blocks of an information processing terminal 40 according to the embodiment of the present disclosure.

As illustrated in FIG. 1, the hearing aid system 1 according to the embodiment of the present disclosure includes the hearing aid 2 as a pair of left and right hearing aids, the charger 3 (charging case) that houses the hearing aid 2 and charges the hearing aid 2, and the information processing terminal 40 such as a smartphone capable of communicating with at least one of the hearing aid 2 and the charger 3. Hereinafter, each of the devices included in the hearing aid system 1 according to the embodiment of the present disclosure will be sequentially described. In the following description, it is assumed that the hearing aid 2 is constituted by a pair of both ears, but the embodiment of the present disclosure is not limited thereto, and the hearing aid 2 may be a single-ear type in which the hearing aid 2 is worn on one of the left and right ears.

First, a functional configuration of the hearing aid 2 will be described. In the embodiment of the present disclosure, at least a part of the hearing aid 2 can be configured to be worn, for example, on a part of an ear canal of a user. Note that the appearance of the hearing aid 2 according to the embodiment of the present disclosure will be described later. As illustrated in FIG. 2, the hearing aid 2 mainly includes a sound collection unit 20 (20b, 20f), a signal processing unit 21, an output unit 22, a battery 25, a connection unit 26, communication units 27 and 30, a storage unit 28, and a control unit 29.

The sound collection unit 20 includes an outer (feedforward) sound collection unit 20f that collects sound in an outer region of the ear canal and an inner (feedback) sound collection unit 20b that collects sound in an inner region of the ear canal.

Note that the hearing aid 2 according to the embodiment of the present disclosure only needs to be provided with the outer sound collection unit 20f that collects at least sound in the outer region of the ear canal. Each sound collection unit 20 includes a microphone (hereinafter, also referred to as a microphone) 201 and an analog/digital (A/D) converter 202. The microphone 201 collects sound, generates an analog sound signal (audio signal), and outputs the analog sound signal to the A/D converter 202. The A/D converter 202 performs digital conversion processing on the analog sound signal input from the microphone 201, and outputs the digitized sound signal to the signal processing unit 21.

Under the control of the control unit 29 described later, the signal processing unit 21 performs predetermined signal processing on the digital sound signal input from the sound collection unit 20, and outputs the digital sound signal to the output unit 22. Here, examples of the predetermined signal processing include filtering processing of separating a sound signal for each predetermined frequency band, amplification processing of amplifying the sound signal with a predetermined amplification amount for each predetermined frequency band on which the filtering processing has been performed, noise reduction processing, howling cancellation processing, and the like. The signal processing unit 21 can include, for example, a memory and a processor having hardware such as a digital signal processor (DSP).

The output unit 22 includes a digital/analog (D/A) converter 221 and a receiver 222. The D/A converter 221 performs analog conversion processing on the digital sound signal input from the signal processing unit 21 and outputs the sound signal to the receiver 222. The receiver 222 outputs an output sound (sound) corresponding to the analog sound signal input from the D/A converter 221. The receiver 222 can be configured using, for example, a speaker or the like.

The battery 25 supplies power to each of the units constituting the hearing aid 2. The battery 25 can be constituted by, for example, a rechargeable secondary battery such as a lithium ion battery. Furthermore, the battery 25 can be charged with power supplied from the charger 3 via the connection unit 26.

For example, when the hearing aid 2 is housed in the charger 3, the connection unit 26 is connected to a connection unit of the charger 3, and can receive power and various types of information from the charger 3 and output various types of information to the charger 3. The connection unit 26 can be configured using, for example, one or a plurality of pins.

The communication unit 27 can communicate with the charger 3 or the information processing terminal 40 according to a predetermined communication standard via a communication network under the control of the control unit 29. Here, as the predetermined communication standard, for example, Wi-Fi (registered trademark), Bluetooth (registered trademark), and the like are assumed. The communication unit 27 can be configured using, for example, a communication module or the like. Furthermore, under the control of the control unit 29, the communication unit 30 can communicate with the other hearing aid 2 by short-range communication such as near field magnetic induction (NFMI).

The storage unit 28 stores various types of information regarding the hearing aid 2. The storage unit 28 can be configured using, for example, a random access memory (RAM), a read only memory (ROM), a memory card, and the like. The storage unit 28 can store a program 281 executed by the hearing aid 2 and various data 282 used by the hearing aid 2. For example, the data 282 can include the age of the user, whether or not the user has experience using the hearing aid 2, the gender of the user, and the like. Furthermore, examples of the data can include the use time of the user's hearing aid 2 clocked by a clocking unit (not illustrated). In addition, the clocking unit can be provided inside the hearing aid 2, and can measure a date and time and output the time measurement result to the control unit 29 and the like. The clocking unit can be configured using, for example, a timing generator, a timer having a clocking function, or the like.

The control unit 29 controls each of the units constituting the hearing aid 2. The control unit 29 can be configured using, for example, a memory and a processor having hardware such as a central processing unit (CPU) or a digital signal processor (DSP). The control unit 29 reads the stored program 281 into a work area of the memory, executes the program 281 to control each of the units and the like through the execution of the program by the processor.

Although not illustrated in FIG. 2, the hearing aid 2 may have an operation unit. The operation unit can receive an input of a start signal (trigger signal) for starting the hearing aid 2 and output the received start signal to the control unit 29. The operation unit can be configured using, for example, a push switch, a button, a touch panel, or the like.

In addition, the hearing aid 2 may be equipped with a biological information sensor (not illustrated) which is a non-invasive sensor device capable of acquiring various types of biological information (sensing data) of the user. Examples of the biological information sensor include a blood flow sensor that detects the pulse, heart rate, blood flow, blood oxygen, and the like of the user.

Furthermore, the hearing aid 2 may be equipped with an inertial measurement unit (IMU) (not illustrated) capable of acquiring information of the posture and movement of the user. Specifically, the IMU includes an acceleration sensor that is an inertial sensor that acquires acceleration, a gyro sensor (angular velocity sensor) that is an inertial sensor that acquires an angular velocity, and the like.

Furthermore, the hearing aid 2 may include a positioning sensor (not illustrated) capable of acquiring information of the position of the user. The positioning sensor is a sensor that detects the position of the target user wearing the hearing aid 2, and can be specifically a global navigation satellite system (GNSS) receiver or the like. In this case, the positioning sensor can generate sensing data indicating the latitude and longitude of the current location of the target user based on a signal from a GNSS satellite. In addition, since the relative positional relationship of the user can be detected from, for example, information of radio frequency identification (RFID), a Wi-Fi access point, a radio base station, or the like, the hearing aid 2 may be equipped with such a communication device as the positioning sensor.

Next, a functional configuration of the charger 3 will be described. As illustrated in FIG. 2, the charger 3 mainly includes a display unit 31, a battery 32, a housing unit 33, a communication unit 34, a storage unit 35, and a control unit 36.

The display unit 31 displays various states regarding the hearing aid 2 under the control of the control unit 36. For example, the display unit 31 can display information indicating that the hearing aid 2 is being charged and information indicating that various types of information are being received from the information processing terminal 40. The display unit 31 can be configured using, for example, a light emitting diode (LED) or the like.

The battery 32 supplies power to each of the units constituting the hearing aid 2 and the charger 3 housed in the housing unit 33 via a connection unit 331 provided in the housing unit 33. The battery 32 can be configured using, for example, a rechargeable secondary battery such as a lithium ion battery.

In a case where the hearing aid 2 has two left and right channels, the housing unit 33 individually houses the hearing aid 2. Note that the hearing aid 2 may be a single-ear type. In addition, the housing unit 33 is provided with the connection unit 331 connectable to the connection unit 26 of the hearing aid 2. When the hearing aid 2 is housed in the housing unit 33, the connection unit 331 is connected to the connection unit 26 of the hearing aid 2, transmits power from the battery 32 and various types of information from the control unit 36, receives various types of information from the hearing aid 2, and outputs the information to the control unit 36. The connection unit 331 can be configured using, for example, one or a plurality of pins.

The communication unit 34 communicates with the information processing terminal 40 according to a predetermined communication standard via a communication network under the control of the control unit 36. The communication unit 34 can be configured using, for example, a communication module.

The storage unit 35 stores various programs 351 executed by the charger 3. The storage unit 35 can be configured using, for example, a RAM, a ROM, a flash memory, a memory card, and the like.

The control unit 36 controls each of the units constituting the charger 3. For example, when the hearing aid 2 is housed in the housing unit 33, the control unit 36 supplies power from the battery 32 via the connection unit 331. The control unit 36 can be configured using, for example, a memory and a processor having hardware such as a CPU or a DSP. The control unit 36 reads the programs 351 into a work area of the memory and executes the programs 351 to control each of the units and the like through the execution of the programs by the processor.

Next, a functional configuration of the information processing terminal 40 will be described. As illustrated in FIG. 3, the information processing terminal 40 mainly includes an input unit 41, a communication unit 42, an output unit 43, a display unit 44, a storage unit 45, and a control unit 46.

The input unit 41 receives inputs of various operations from the user, and outputs a signal corresponding to the received operations to the control unit 46. The input unit 41 can be configured using, for example, a switch, a touch panel, and the like.

The communication unit 42 communicates with the charger 3 or the hearing aid 2 via a communication network under the control of the control unit 46. The communication unit 42 can be configured using, for example, a communication module.

The output unit 43 outputs a sound volume of a predetermined sound pressure level for each predetermined frequency band under the control of the control unit 46. The output unit 43 can be configured using, for example, a speaker or the like.

The display unit 44 displays various types of information regarding the information processing terminal 40 and information regarding the hearing aid 2 under the control of the control unit 46. The display unit 44 can be configured using, for example, a liquid crystal display, an organic electroluminescent display (EL display), or the like.

The storage unit 45 stores various types of information regarding the information processing terminal 40. The storage unit 45 stores various programs 451 and the like executed by the information processing terminal 40. The storage unit 45 can be configured using, for example, a recording medium such as a RAM, a ROM, a flash memory, or a memory card.

The control unit 46 controls each of the units constituting the information processing terminal 40. The control unit 46 can be configured using, for example, a memory and a processor having hardware such as a CPU. The control unit 46 reads the programs stored in the storage unit 45 into a work area of the memory and executes the programs to control each of the units and the like through the execution of the programs by the processor.

Furthermore, the information processing terminal 40 may include a positioning sensor (not illustrated). The positioning sensor is a sensor that detects the position of the user carrying the information processing terminal 40, and can be specifically a GNSS receiver or the like. In this case, the positioning sensor can generate sensing data indicating the latitude and longitude of the current location of the user based on a signal from a GNSS satellite. Furthermore, since the relative positional relationship of the user can be detected from, for example, information of RFID, a Wi-Fi access point, a wireless base station, or the like, the information processing terminal 40 may be equipped with such a communication device as the positioning sensor.

Furthermore, the information processing terminal 40 may be equipped with an imaging device (not illustrated). Specifically, the imaging device can include an imaging element (not illustrated) such as a complementary MOS (CMOS) image sensor, and a signal processing circuit (not illustrated) that performs imaging signal processing on a signal photoelectrically converted by the imaging element. Furthermore, the imaging device can further include an optical system mechanism (not illustrated) including an imaging lens, a diaphragm mechanism, a zoom lens, a focus lens, and the like, and a drive system mechanism (not illustrated) that controls the operation of the optical system mechanism.

In the embodiment of the present disclosure, the functional configuration of the hearing aid system 1 and each device included in the hearing aid system 1 is not limited to the form illustrated in FIGS. 1 to 3. For example, as described later, the hearing aid system 1 may include a server or the like.

Note that, in the description of the embodiment of the present disclosure described below, a case where the present disclosure is applied to the hearing aid system 1 will be described as an example, but the embodiment of the present disclosure is not limited to the application to the hearing aid system 1, and can also be applied to a system including another auditory device (for example, earphones, a headphone, a sound collector, or the like).

### 2. Background

Next, the background leading to the embodiments of the present disclosure created by the present inventors will be described.

When a user with a disorder such as hearing loss wears the hearing aid 2 and hears surrounding sound with the hearing aid 2, the user can clearly hear the sound with the hearing aid 2, but it may be difficult for the user to understand from which direction (direction of arrival) the sound is heard. Therefore, for example, when the user wears the hearing aid 2 and goes out, even when the user can recognize that an automobile is approaching from the sound, the user cannot predict from which direction the automobile will approach. In such a case, since the user does not know the direction of arrival of the sound, the user cannot predict the direction in which the automobile is heading, and cannot quickly take an action such as moving to avoid the automobile.

Therefore, it is conceivable to mount a microphone having directivity for determining a direction of arrival of a sound in the hearing aid 2, but the hearing aid 2 is limited in its size, and it is difficult to mount a plurality of microphones having directivity.

In addition, sound is transmitted to the human ear canal through reflection and diffraction in the human body and auricle. Such a transfer characteristic in the user's body or auricle is expressed by a head-related transfer function (HRTF). Normally, by hearing sound reflecting the transmission characteristics of the body and the auricle, the human can estimate the direction of arrival of the sound. Therefore, it is also conceivable to reduce the size of the hearing aid 2 or optimize the shape of the hearing aid 2 so that the sound from the hearing aid 2 includes a sound component reflecting the transmission characteristics of the body and the auricle. However, since HRTFs differ for each person, it is difficult to optimize the hearing aid 2 so as to be able to provide the user with a sound reflecting the transmission characteristics to such an extent that the user can predict the direction of arrival of the sound.

Therefore, for example, in the technique disclosed in PTL 1, the sound pressure of sound is compared for each direction of arrival, and an actuator corresponding to a direction of arrival of a sound having a large sound pressure is vibrated to present the direction of arrival of the sound to the user. However, the device disclosed in PTL 1 is large, and it is difficult to mount the device in the hearing aid 2.

Furthermore, for example, in the technology disclosed in NPL 1 described above, a plurality of Helmholtz resonators is used to give different frequency characteristics to a sound for each direction of arrival, and the sound having the frequency characteristics is analyzed by an algorithm obtained by machine learning. Then, in the technique disclosed in NPL 1, a word included in a sound is recognized, speaker separation is performed according to a direction of arrival detected based on a frequency characteristic, and the content of an utterance for each speaker is presented to a user. However, the resonators disclosed in NPL 1 have a radius of 20 cm, and is difficult to implement them in the hearing aid 2. In addition, in the technique disclosed in NPL 1, it is necessary to perform machine learning on characteristics of various words to be uttered in advance and generate an algorithm for recognition in advance.

Furthermore, in the technology disclosed in NPL 1, since recognition of uttered words and speaker separation are performed, a complex configuration is required, and it takes time to present a result to the user. Therefore, although the technology disclosed in NPL 1 can recognize a direction of arrival of a sound, it is not a technology that can be easily used by anyone in daily life.

Therefore, in view of such a situation, the present inventors have considered that there is a need for a device that enables a user who uses the hearing aid 2 to recognize a direction of arrival of a sound similarly to a healthy person, and that can be easily mounted on the hearing aid 2 that the user wears on a daily basis, and have conducted intensive studies. Then, the present inventors have created embodiments of the present disclosure described below while conducting studies. According to the embodiment of the present disclosure, the user can recognize a direction of arrival of a sound similarly to a healthy person only by attaching, to the hearing aid 2, a hearing aid component having a size that can be mounted on the hearing aid 2. Hereinafter, details of embodiments of the present disclosure created by the present inventors will be sequentially described.

### 3. First Embodiment

### 3.1 External Configuration of Hearing Aid

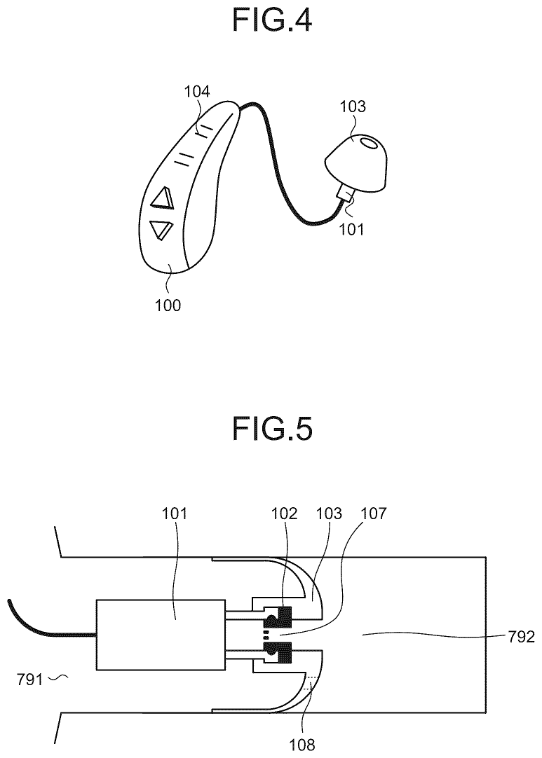

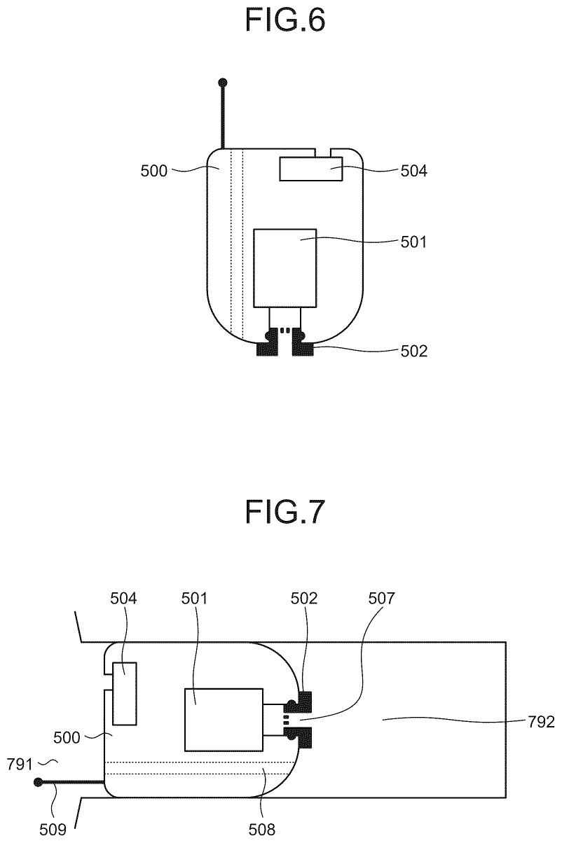

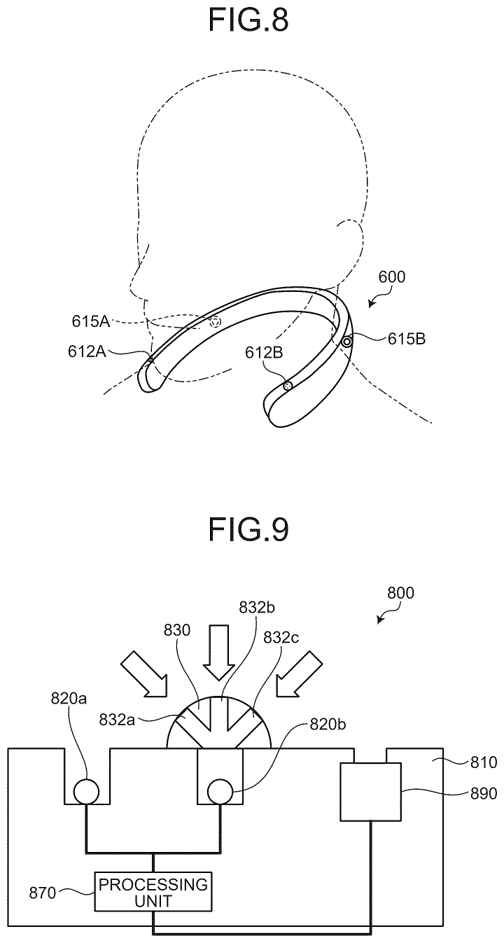

First, a specific external configuration of a hearing aid according to the present embodiment or of a hearing aid to which a hearing aid component (component for a sound processing device) according to the present embodiment can be attached will be described with reference to FIGS. 1 and 4 to 8. FIG. 4 is a diagram illustrating a configuration example of a behind-the-ear hearing aid 100 according to the present embodiment, and FIG. 5 is a cross-sectional view illustrating a state in which a receiver 101 of the behind-the-ear hearing aid 100 according to the present embodiment is inserted into an ear canal of a user. FIG. 6 is a diagram illustrating a configuration example of an in-the-ear hearing aid 500 according to the present embodiment, and FIG. 7 is a cross-sectional view illustrating a state in which the in-the-ear hearing aid 500 according to the present embodiment is inserted into the ear canal of the user. In addition, FIG. 8 is a diagram illustrating a configuration example of a neck band type hearing aid 600 according to the present embodiment.

A hearing aid 2 according to the present embodiment can be in the form of an earphone used when listening to audio content, like the hearing aid 2 illustrated in FIG. 1 described above, for example. In this case, although not illustrated in FIG. 1, the hearing aid 2 mainly includes a receiver (output unit) 222 and a microphone 201 (see FIG. 2). The microphone 201 is provided on a surface of a housing of the hearing aid 2 that is located outside the ear canal of the user, collects sound around the user, and transmits an audio signal to a signal processing unit 21 (see FIG. 2). Furthermore, the signal processing unit 21 amplifies the transmitted audio signal in accordance with the hearing of the user, and transmits the audio signal to the receiver 222. The receiver 222 is a speaker that outputs the transmitted audio signal. Furthermore, an ear tip to be worn on the user's ear canal may be connected to the receiver 222. The ear tip is also referred to as an ear dome, and one molded in accordance with an ear mold of each user is also referred to as an ear mold. Then, when the user uses the hearing aid 2, the hearing aid 2 is inserted into the ear canal through the ear tip.

Furthermore, in the present embodiment, although not illustrated in FIG. 1, it is preferable that a plurality of microphones (first sound collection units) 201 be provided in the hearing aid 2, and further, the hearing aid component according to the present embodiment to be described later is attached to at least one of the plurality of microphones 201.

In addition, in the present embodiment, the earphone-type hearing aid 2 may be provided with another microphone (not illustrated) that can be used for noise canceling at the time of listening to audio content and is provided on a surface of the housing of the hearing aid 2 that is located inside the ear canal of the user. The hearing aid 2 can accurately cancel noise and output the audio content as a clearer sound by acquiring sound in the ear canal of the user with the microphone and inverting and outputting an audio signal of the acquired sound.

Furthermore, in the present embodiment, the hearing aid may be in the form of a headphone used when listening to audio content.

Furthermore, the hearing aid 2 according to the present embodiment may be in the form of a behind-the-ear hearing aid or an in-the-ear hearing aid. The behind-the-ear hearing aid is referred to as, for example, a behind-the-ear (BTE)/receiver-in-the-canal (RIC) or the like. In addition, the in-the-ear hearing aid is referred to as, for example, in-the-ear (ITE)/in-the-canal (ITC)/completely in-the-canal (CIC)/invisible-in-the-canal (IIC).

As illustrated in FIG. 4, the behind-the-ear hearing aid 100 mainly includes a receiver (output unit) 101, an ear tip (attachment component) 103, and a microphone (sound collection unit) 104. The microphone 104 collects surrounding sound and transmits an audio signal to a signal processing unit (not illustrated). Furthermore, the above-described signal processing unit amplifies the transmitted audio signal in accordance with the hearing of the user, and transmits the audio signal to the receiver 101. The receiver 101 is a speaker that outputs the transmitted audio signal. Furthermore, the ear tip 103 to be worn on the user's ear canal is connected to the receiver 101. The ear tip 103 is also referred to as an ear dome, and one molded in accordance with an ear mold of each user is also referred to as an ear mold. Then, when the user uses the hearing aid 100, the hearing aid 100 is hung on the auricle, and the receiver 101 is inserted into the ear canal through the ear tip 103.

Furthermore, in the present embodiment, although not illustrated in FIG. 4, a plurality of microphones (first sound collection units) 104 is preferably provided, and the hearing aid component to be described later is attached to at least one of the plurality of microphones 104.

FIG. 5 illustrates a state in which the receiver 101 of the behind-the-ear hearing aid 100 is inserted into the ear canal of the user. The ear tip 103 is provided with a first hole 107 as a sound outlet of the receiver 101, and an earwax intrusion preventing filter 102 for preventing intrusion of earwax is provided at the first hole 107. Therefore, the sound outlet of the receiver 101 communicates with the inner side 792 of the ear canal via the first hole 107 and the earwax intrusion preventing filter 102. Furthermore, the inner side 792 of the user's ear canal and the outer side 791 of the ear canal are separated by the ear tip 103. In addition, the ear tip 103 may be provided with a second hole 108 for communicating the inner side 792 of the ear canal with the outer side 791 of the ear canal in order to prevent muffling of the own voice and secure air flow. The second hole 108 is also referred to as a vent. Note that the number of second holes 108 may be one or more. Further, one side or both sides of the second hole 108 may be a mesh structure or another sound transmitting member.

In addition, also in the behind-the-ear hearing aid 100, another microphone (not illustrated) that can be used for noise canceling when listening to audio content may be provided in the receiver 101.

As illustrated in FIG. 6, the in-the-ear hearing aid 500 mainly includes a receiver 501 and a microphone 504. The microphone 504 collects surrounding sound and transmits an audio signal to a signal processing unit (not illustrated). Furthermore, the above-described signal processing unit amplifies the transmitted audio signal in accordance with the hearing of the user, and transmits the audio signal to the receiver 501. The receiver 501 outputs the transmitted audio signal. Then, when the user uses the hearing aid 500, the hearing aid 500 is inserted into the ear canal of the user.

FIG. 7 illustrates a state in which the in-the-ear hearing aid 500 is inserted into the ear canal of the user. As described above, when the user uses the hearing aid 500, the hearing aid 500 is inserted into the ear canal of the user. A housing (housing unit) which is a main body of the hearing aid 500 incorporates the receiver 501 and the microphone 504 described above. Furthermore, to remove the hearing aid 500 from the ear canal, the user pulls a gut 509 connected to the housing. Note that, depending on the size of the in-the-ear hearing aid 500, the gut 509 may not be provided.

Further, in the present embodiment, although not illustrated in FIGS. 6 and 7, a plurality of microphones (first sound collection units) 504 is preferably provided in the housing, and the hearing aid component to be described later is attached to at least one of the plurality of microphones 504.

Furthermore, the housing is provided with a first hole 507 as a sound outlet of the receiver 501, and an earwax intrusion preventing filter 502 for preventing intrusion of earwax is provided at the first hole 507. Therefore, the sound outlet of the receiver 501 communicates with the inner side 792 of the ear canal via the first hole 507 and the earwax intrusion preventing filter 502. Further, the microphone 504 is provided at a position away from the first hole 507 by a predetermined distance. Furthermore, the inner side 792 of the user's ear canal and the outer side 791 of the ear canal are separated by the hearing aid 500. Then, the hearing aid 500 may be provided with a second hole 508 for communicating the inner side 792 of the ear canal with the outer side 791 of the ear canal in order to prevent muffling of the own voice and secure air flow. Note that the number of second holes 508 may be one or more. Further, one side or both sides of the second hole 508 may be a mesh structure or another sound transmitting member.

In addition, also in the hearing aid 500, another microphone (not illustrated) that can be used for noise canceling when listening to audio content may be provided inside the first hole 507 or in the vicinity of the opening of the first hole 507.

Furthermore, the hearing aid according to the present embodiment is not limited to a form in which a part thereof is inserted into and worn on the ear canal of the user, and may be, for example, a neck band type hearing aid worn on the neck (part of the body) of the user.

As illustrated in FIG. 8, the neck band type hearing aid 600 includes a wearing unit having a shape that makes a half circle from both sides of the user's neck to the back side (back side), and is worn by the user by being hung on the user's neck. Note that, as illustrated in FIG. 8, the wearing unit may be worn on the neck of the user while being in close contact with the neck of the user, or may be worn on the neck of the user separately from the neck of the user.

As illustrated in FIG. 8, the hearing aid 600 includes a plurality of microphones 612A and 612B and speakers 615A and 615B. The microphones 612A and 612B acquire sound data such as environmental sound around the user. Furthermore, the speakers 615A and 615B output sound signals.

Note that, in the present embodiment, the number of microphones 612 is not limited to two, and may be one, or three or more microphones 612 may be provided. Furthermore, in the present embodiment, the hearing aid component to be described later is attached to at least one of the plurality of microphones 612.

Note that, in the embodiment of the present disclosure, the hearing aid is not limited to the forms illustrated in FIGS. 1 and 4 to 8, and can be in various forms.

### 3.2 Hearing Aid to which Hearing Aid Component is Attached

Next, an outline of a hearing aid 800 to which the hearing aid component according to the embodiment of the present disclosure is attached will be described with reference to FIG. 9. FIG. 9 is an explanatory diagram for explaining the hearing aid 800 to which the hearing aid component according to the present embodiment is attached.

As illustrated in FIG. 9, the hearing aid (sound processing device) 800 according to the present embodiment mainly includes, for example, microphones 820a and 820b, a processing unit 870, and a receiver (output unit) 890 that are provided in a housing 810. Note that, in the present embodiment, the microphones 820a and 820b, the processing unit 870, and the receiver 890 may be provided in different separate housings. Furthermore, in the present embodiment, the processing unit 870 and the receiver 890 may be provided in different separate housings. That is, the hearing aid 800 according to the present embodiment is not limited to the configuration illustrated in FIG. 9. Hereinafter, each component of the hearing aid 800 according to the present embodiment will be sequentially described.

(Microphones 820a, 820b) The microphones 820a and 820b are provided in the housing 810, collect surrounding sound, convert an analog signal (acoustic signal) based on the collected sound into a digital signal, and output the digital signal to the processing unit 870 described later.

Furthermore, in the present embodiment, an acoustic metamaterial structure (acoustic metamaterial) 830 is attached to the microphone (first sound collection unit) 820b as the hearing aid component. Therefore, the microphone 820b can acquire sound transmitted in the acoustic metamaterial structure 830. The sound collected by the microphone 820b is used to recognize a direction of arrival of a sound. Further, in the present embodiment, microphone 820b to which the acoustic metamaterial structure 830 is attached is preferably provided on a surface of the housing 810 that is located outside the ear canal of the user. Note that details of the acoustic metamaterial structure 830 will be described later.

Meanwhile, the acoustic metamaterial structure 830 is not attached to the microphone (second sound collection unit) 820a. Therefore, the microphone 820a can acquire sound around the user without using the acoustic metamaterial structure 830, in other words, can acquire the sound not affected by the acoustic metamaterial structure 830. Then, the sound collected by the microphone 820a can be used to correct a sound to be output to the user.

Note that, in the present embodiment, the hearing aid 800 only needs to include at least one microphone 820b to which the acoustic metamaterial structure 830 is attached, and may not include the microphone 820a to which the acoustic metamaterial structure 830 is not attached. In the present embodiment, the hearing aid 800 may include a plurality of microphones 820a to which the acoustic metamaterial structure 830 is not attached and a plurality of microphones 820b to which the acoustic metamaterial structure 830 is attached. That is, in the present embodiment, the hearing aid 800 can include a plurality of microphones 820a and 820b within a mountable range of the hearing aid 800.

### (Acoustic Metamaterial Structure 830)

As described above, the acoustic metamaterial structure 830 is attached to the microphone 820b as the hearing aid component. The sound transmitted in the acoustic metamaterial structure 830 is used to recognize the direction of arrival of the sound. Specifically, the acoustic metamaterial structure 830 can give a predetermined characteristic to the sound according to the direction of arrival of the sound. Details of the acoustic metamaterial structure 830 according to the present embodiment will be described below.

In the present embodiment, as illustrated in FIG. 9, the acoustic metamaterial structure 830 is preferably configured to be attachable and detachable to and from an inlet of the microphone 820b, and is more preferably configured to be attachable to the inlet of the microphone 820b of the hearing aid 800 having various forms. In the present embodiment, the acoustic metamaterial structure 830 is configured to be attachable and detachable, and thus acoustic metamaterial structures 830 having various structures can be produced and replaced in accordance with user's preference and hearing, and a change in hearing characteristics with age.

As illustrated in FIG. 9, the acoustic metamaterial structure 830 has a plurality of openings 832a, 832b, and 832c that open toward different directions to obtain sounds coming from different directions. Inside each of the openings 832a, 832b, and 832c, a resonating body capable of giving a predetermined frequency characteristic as a characteristic to a sound that has arrived through each of the openings 832a, 832b, and 832c is provided. Specifically, the resonating bodies provided in the openings 832a, 832b, and 832c have different structures and sizes. Then, since the resonating bodies have different structures and sizes, sounds in specific frequency bands different for each resonating body can be selectively amplified or transmitted. Therefore, the acoustic metamaterial structure 830 according to the present embodiment can give different frequency characteristics to sounds arriving through the plurality of openings 832a, 832b, 832c opening in different directions, that is, sounds having different directions of arrival. Further, the acoustic metamaterial structure 830 may be capable of changing not only the frequency characteristics described above but also the wavelengths and amplitudes of sounds arriving through the openings 832a, 832b, 832c. Although the three openings 832a, 832b, and 832c are exemplified herein as the acoustic metamaterial structure 830, the present embodiment is not limited thereto, and two or less openings or four or more openings may be provided. In the present embodiment, the resonating bodies provided in the openings 832a, 832b, and 832c may have the same structure and size.

Furthermore, in the present embodiment, among the openings 832a, 832b, and 832c, the opening 832a and the opening 832b may have the same structure and size, and the opening 832c may have a structure and size different from those of the openings 832a and 832b. That is, in the present embodiment, some of the plurality of openings 832 may have different structures and sizes, or some of the openings may have the same structure and size.

Then, the single microphone 820b can acquire a plurality of sounds having different frequency characteristics given by the acoustic metamaterial structure 830. That is, in the present embodiment, it is not necessary to provide a plurality of microphones for each direction of arrival of a sound, and the hearing aid 800 is configured to collect a plurality of sounds having different directions of arrival by the single microphone 820b. Further, as will be described later, the acoustic metamaterial structure 830 has a very small size according to the wavelength of sound acting thereon, and thus can be mounted on the small hearing aid 800. Therefore, the present embodiment can be implemented even with the small hearing aid 800 having a limitation on the number of microphones that can be installed.

Note that details of the above-described resonating bodies will be described later.

### (Processing Unit 870)

The processing unit 870 performs predetermined signal processing on digital sound signals output from the microphones 820a and 820b, and outputs the digital sound signals to the receiver 890 described later. Note that details of the configuration of the processing unit 870 will be described later.

### (Receiver 890)

The receiver 890 converts the digital sound signals output from the processing unit 870 into analog sound signals and outputs an output sound (sound) corresponding to the analog sound signals.

In the present embodiment, the hearing aid 800 is not limited to the configuration illustrated in FIG. 9. Furthermore, the hearing aid 800 according to the present embodiment can constitute the hearing aid system 1 together with the charger 3 and the information processing terminal 40 as described with reference to FIG. 1.

### 3.3 Resonating Bodies

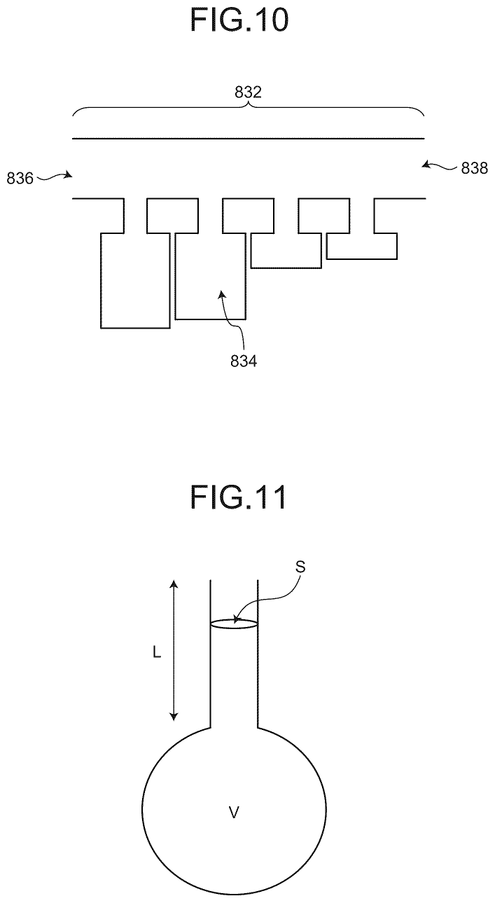

Next, the resonating bodies according to the embodiment of the present disclosure will be described with reference to FIGS. 10 to 13. FIGS. 10 and 13 are explanatory diagrams for explaining the resonating bodies according to the present embodiment.

In the present embodiment, as described above, the acoustic metamaterial structure 830 has the plurality of openings 832a, 832b, and 832c that open in different directions, and the resonating bodies that are provided inside the openings 832a, 832b, and 832c and can give predetermined frequency characteristics to sounds arriving through the openings 832a, 832b, and 832c. Since the resonating bodies provided in the openings 832a, 832b, and 832c have different structures and sizes, sounds in specific frequency bands different for each resonating body can be selectively amplified or transmitted. Therefore, the acoustic metamaterial structure 830 according to the present embodiment can give different frequency characteristics to sounds arriving through the plurality of openings 832a, 832b, 832c opening in different directions, that is, sounds having different directions of arrival.

In the present embodiment, each resonating body includes a plurality of resonators (resonance tubes) as described later. A person with hearing loss, an elderly person, or the like has difficulty in hearing a sound having a high frequency, and even a healthy person or the like has difficulty in sensing a sound having a high frequency with high resolution. Therefore, even when the tone or the like of a sound having a high frequency is slightly changed, it does not make a large difference in how the sound is heard. Therefore, in the present embodiment, the resonating bodies included in the acoustic metamaterial structure 830 are preferably configured to give a predetermined characteristic (frequency characteristic) to a component having a high frequency among sounds captured by the hearing aid 800 from around the user. In addition, the resonators having a configuration described below can give a characteristic even if the sizes are considerably small (for example, about 1/7 of the wavelength) with respect to the wavelength of the component to be given the characteristic.

For example, each resonator described below has a very small size, for example, a size of 1 mm or more and several 10 mm or less. Therefore, in the present embodiment, even a resonating body obtained by combining a plurality of such small resonators has a small size, and even an acoustic metamaterial structure 830 including a plurality of such small resonating bodies has a small size. As a result, the acoustic metamaterial structure 830 according to the present embodiment can be attached to even the small hearing aid 800 having a limitation on the size of components that can be mounted.

Note that, in the present embodiment, a sound having a high frequency that is difficult for a person with hearing loss or an elderly person to hear is converted into a sound having a low to medium frequency that can be easily heard by the processing unit 870.

Specifically, in the present embodiment, as illustrated in FIG. 10, the resonating bodies can be a combination of a plurality of Helmholtz resonators 834. Specifically, in the present embodiment, the plurality of Helmholtz resonators 834 having different sizes and structures in the opening 832 are provided between the inlet 836 side of the opening 832 opening toward the outside and the outlet 838 side connected to the microphone 820b.

Specifically, as illustrated in FIG. 11, each Helmholtz resonator 834 has a resonance frequency (natural frequency) determined by the volume V of a cavity, the area S of an opening portion, and the length L of the neck. Therefore, as illustrated in FIG. 10, by combining the plurality of Helmholtz resonators 834 having different sizes and structures, for example, a band pass filter that passes only a specific frequency near the resonance frequency can be formed. Therefore, in the present embodiment, a predetermined frequency characteristic can be given to a sound by using the band pass filter that passes only the specific frequency. In the present embodiment, by changing a combination of Helmholtz resonators 834 for each of the openings 832 opening in the different directions, it is possible to give different frequency characteristics to sounds having different directions of arrival.

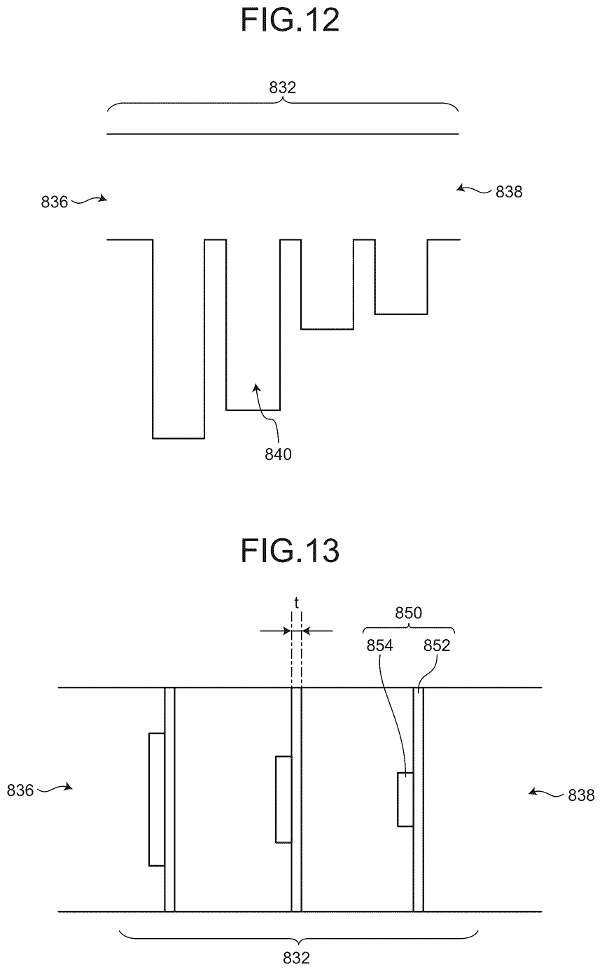

Furthermore, in the present embodiment, the resonating bodies are not limited to a combination of the Helmholtz resonators 834, and a plurality of side branch resonance tubes 840 may be combined. Similarly to the Helmholtz resonators 834, the side branch resonance tubes 840 also have a resonance frequency (natural frequency) determined by the diameters and lengths of the tubes. Therefore, by combining the plurality of side branch resonance tubes 840 having different diameters and lengths, for example, a band pass filter (notch filter) that passes only a specific frequency can be formed. Then, for example, in the present embodiment, as illustrated in FIG. 12, a plurality of side branch resonance tubes 840 having different tube diameters and lengths in the opening 832 may be provided between the inlet 836 side of the opening 832 opening toward the outside and the outlet 838 side connected to the microphone 820b. Therefore, in the present embodiment, a predetermined frequency characteristic can be given to a sound by using the band pass filter that passes only the specific frequency. Then, in the present embodiment, by changing a combination of side branch resonance tubes 840 for each of the openings 832 opening in the different directions, it is possible to give different frequency characteristics to sounds having different directions of arrival.

Furthermore, in the present embodiment, the resonating bodies may be a combination of membrane resonators 850. As illustrated in FIG. 13, each membrane resonator 850 includes a membrane 852 and a weight 854 added to the membrane 852. The membrane resonator 850 has a resonance frequency (natural frequency) determined by the thickness t and hardness of the membrane 852 and the weight of the weight 854. Therefore, by combining a plurality of membrane resonators 850 having different thicknesses t and weights, for example, a band pass filter that passes only a specific frequency can be formed. Therefore, in the present embodiment, a predetermined frequency characteristic can be given to a sound by using the band pass filter that passes only the specific frequency. In the present embodiment, by changing a combination of membrane resonators 850 for each of the openings 832 opening in different directions, it is possible to give different frequency characteristics to sounds having different directions of arrival.

In the present embodiment, it is difficult to create the membrane resonators 850 so as to have a desired resonance frequency with high accuracy, and there is a possibility that the resonance frequency may change due to degradation of the membrane 852 over time. Therefore, it is preferable to use the Helmholtz resonators 834 or the side branch resonance tubes 840 as the resonating bodies.

In the present embodiment, the resonating bodies are not limited to the forms illustrated in FIGS. 10, 12, and 13.

### 3.4 Processing Unit

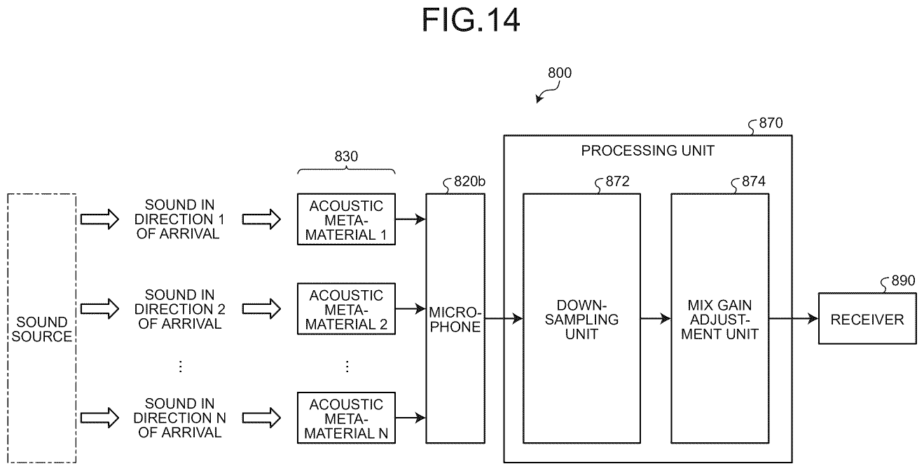

Next, details of the processing unit 870 according to the embodiment of the present disclosure will be described with reference to FIG. 14. FIG. 14 is a block diagram for describing functional blocks of the processing unit 870 according to the present embodiment.

As illustrated in FIG. 14, the single microphone 820b collects sounds from directions 1 and 2 to N of arrival through acoustic metamaterials 1 and 2 to N which are a combination of the plurality of resonators provided in the openings 832 of the acoustic metamaterial structure 830. As described above, a sound that has passed through an opening 832 of the acoustic metamaterial structure 830 is given a frequency characteristic in accordance with a direction of arrival of the sound. Then, the microphone 820b converts an analog signal (audio signal) based on the collected sound into a digital signal and outputs the digital signal to the processing unit 870. Then, the processing unit 870 performs predetermined signal processing on the digital signal output from the microphone 820b, and outputs the digital signal to the receiver 890 described later.

Furthermore, as illustrated in FIG. 14, the processing unit 870 mainly includes a down-sampling unit (converter) 872 and a MIX gain adjustment unit (amplification unit) 874. Details of each functional unit of the processing unit 870 will be sequentially described below.

### (Down-Sampling Unit 872)

The down-sampling unit 872 converts a component having a frequency (first frequency) within a predetermined frequency range (first frequency range) included in the sound acquired by the microphone 820b into a component having a frequency (second frequency) within another predetermined frequency range (second frequency range) according to the auditory characteristics of the user. A person with hearing loss or an elderly person often has difficulty in hearing a sound having a high frequency.

Therefore, the down-sampling unit 872 converts a sound having a high frequency into a sound having a low to medium frequency that is easy to hear. In addition, even for a person with normal hearing, sound resolution is improved by converting a sound having a high frequency into a sound having a low or medium frequency. Furthermore, the down-sampling unit 872 outputs a sound signal including the frequency-converted component to the MIX gain adjustment unit 874 described later.

### (MIX Gain Adjustment Unit 874)

The MIX gain adjustment unit 874 amplifies the sound signal from the down-sampling unit 872 with a gain according to the auditory characteristics of the user and a desire, and outputs the amplified sound to the receiver 890. Note that the MIX gain adjustment unit 874 may detect a volume or the like using the sound signal from the down-sampling unit 872, and adjust the gain according to the result of the detection.

In the present embodiment, the processing unit 870 is not limited to the configuration illustrated in FIG. 14.

### 3.5 Variation of Processing Unit

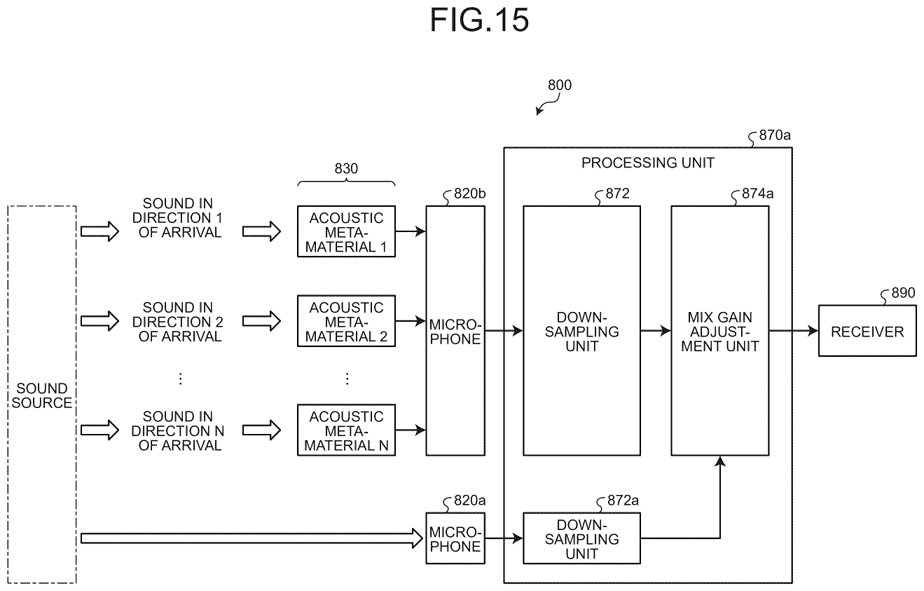

In the present embodiment, a sound collected by the microphone 820b to which the acoustic metamaterial structure 830 is not attached may be used to improve the quality of a sound to be output to the user. Therefore, a variation of the processing unit 870a capable of performing such processing will be described with reference to FIG. 15. FIG. 15 is a block diagram for explaining functional blocks of a processing unit 870a according to a modification of the present embodiment.

In the present modification, as illustrated in FIG. 15, the processing unit 870a includes a down-sampling unit 872 similarly to the above-described embodiment, and further mainly includes a down-sampling unit 872a and a MIX gain adjustment unit 874a. Details of each functional unit of the processing unit 870a will be sequentially described below. Here, since the down-sampling unit 872 is common to the down-sampling unit 872 according to the present embodiment described with reference to FIG. 14, the description of the down-sampling unit 872 is omitted here, and only the down-sampling unit 872a and the MIX gain adjustment unit 874a will be described.

### (Down-Sampling Unit 872a)

The down-sampling unit 872a converts a component having a frequency within a predetermined frequency range (first frequency range) included in a sound acquired by the microphone 820a into a component having a frequency within another predetermined frequency range (second frequency range) according to the auditory characteristics of the user. Furthermore, the down-sampling unit 872a outputs a sound signal including the frequency-converted component to the MIX gain adjustment unit 874a described later. Note that, in the present modification, the down-sampling unit 872a may not be provided.

### (MIX Gain Adjustment Unit 874a)

The MIX gain adjustment unit 874a amplifies sound signals from the down-sampling units 872 and 872a with a gain according to the auditory characteristics of the user and a desire, and outputs the amplified sounds to the receiver 890. The MIX gain adjustment unit 874a adjusts gains for the respective sounds so as to improve the audibility or the like of the user. In the present modification, a sound given a predetermined characteristic by the acoustic metamaterial structure 830 and a sound not given the predetermined characteristic by the acoustic metamaterial structure 830 are simultaneously output, so that a sound that is easily heard by the user, has high reproducibility, and is close to an actual sound around the user can be output. In the present embodiment, when a sound having a specific frequency is excluded or weakened by the acoustic metamaterial structure 830, a sound collected by the microphone 820a to which the acoustic metamaterial structure 830 is not attached is output together, so that a sound component having the specific frequency is compensated, and a sound close to an actual sound can be output.

Note that the MIX gain adjustment unit 874a may detect a volume or the like using sound signals from the down-sampling units 872 and 872a, and adjust the gains according to the detection result.

In the present embodiment, the processing unit 870a is not limited to the configuration illustrated in FIG. 15.

### 3.6 Usage

Next, a method of using the hearing aid 800 according to the present embodiment described above will be described. As described above, in the present embodiment, by attaching the acoustic metamaterial structure 830 to the inlet 836 of the microphone 820b of the hearing aid 800, it is possible to give a characteristic specific to each direction of arrival of a sound to the sound. Therefore, in the present embodiment, training of repeatedly causing the user to hear a sound having a characteristic specific to a corresponding direction of arrival while conveying the direction of arrival of the sound by visual means or the like is performed, so that the user acquires the skill of estimating the direction of arrival of the sound based on the heard sound using the plasticity of the human brain. Note that details of such a training method will be described later.

Specifically, a healthy person hears sounds having various directions of arrival and reflecting the HRTF specific to his/her body in daily life, thereby unconsciously estimating a direction of arrival of a sound based on characteristics included in the sounds for each direction of arrival. Therefore, in the present embodiment, the user learns, for each direction of arrival of a sound, a characteristic of the sound by listening to sounds having various directions of arrival in which a transfer function of the acoustic metamaterial structure 830 is newly reflected while being conscious of the directions of arrival. Then, the user can finally obtain the ability to estimate a direction of arrival of a sound based on the characteristic for each direction of arrival of the sound provided by the acoustic metamaterial structure 830.

In the present embodiment, the hearing aid 800 can cause the user to recognize a direction of arrival of a sound by cooperating with the ability of the user to estimate a direction of arrival of a sound obtained by performing training. Therefore, according to the present embodiment, since it is not necessary to provide a special device that estimates a direction of arrival of a sound and presents the result thereof to the user, the hearing aid 800 can have a simple configuration. Furthermore, the present embodiment can be implemented only by attaching the acoustic metamaterial structure 830 as the hearing aid component according to the present embodiment to a conventional hearing aid.

Furthermore, when the hearing aid 800 is used as an earphone (reproduction machine) for listening to audio content instead of listening to surrounding sound, the hearing aid 800 may perform the following processing. Specifically, in a case where information indicating a direction of arrival of a sound and included in audio content is obtained in advance when the audio content is reproduced, the hearing aid 800 may reproduce the audio content after performing processing of adding a characteristic given by the acoustic metamaterial structure 830 to the sound with respect to the corresponding direction of arrival. In this way, since the user can listen to the audio content while recognizing the direction of arrival of the sound included in the audio content, the realistic feeling of the content can be further improved.

In addition, in the present embodiment, a doll type dummy capable of reproducing a transfer function (HRTF) of a human head is used to analyze in advance what kind of characteristics sounds in various directions of arrival will have due to the effect of the transfer function. In the present embodiment, the acoustic metamaterial structure 830 may be configured so that the characteristics obtained by the analysis can be given to the sound in each direction of arrival. In this way, characteristics originally generated by the human body can be given to a sound, so that the user can estimate a direction of arrival of a sound based on a characteristic for each direction of arrival of the sound given by the acoustic metamaterial structure 830 without repeating the above training.

Furthermore, since the HRTFs slightly differ for each person, in the present embodiment, instead of the doll type dummy, the user may actually listen to sounds having various characteristics, and the user may be asked to answer what characteristics the sound has and from which direction of arrival the sound is recognized. By accumulating such answers, it is possible to know from which direction of arrival the user has a tendency to recognize a sound having what kind of characteristics. In the present embodiment, the acoustic metamaterial structure 830 may be configured based on the learned tendency. In this way, the acoustic metamaterial structure 830 can give a characteristic corresponding to the cognitive tendency of the individual user to a sound for each direction of arrival, so that the user can estimate the direction of arrival of the sound based on the characteristic for each direction of arrival of the sound given by the acoustic metamaterial structure 830 without repeating the above training.

### 4. Second Embodiment

Further, in the embodiment of the present disclosure, when a way of giving characteristics (frequency characteristics) by the acoustic metamaterial structure 830 is known, a direction of arrival of a sound can be estimated by an inverse algorithm. Therefore, in a second embodiment described below, a direction of arrival is estimated, and a result thereof is transmitted to an information processing terminal 40 used by a user and is presented to the user in real time. Note that, in the following description, it is described that a direction of arrival is estimated by a hearing aid 800, but the present invention is not limited thereto, and the direction of arrival may be estimated by the information processing terminal 40 or an information processing server on a cloud.

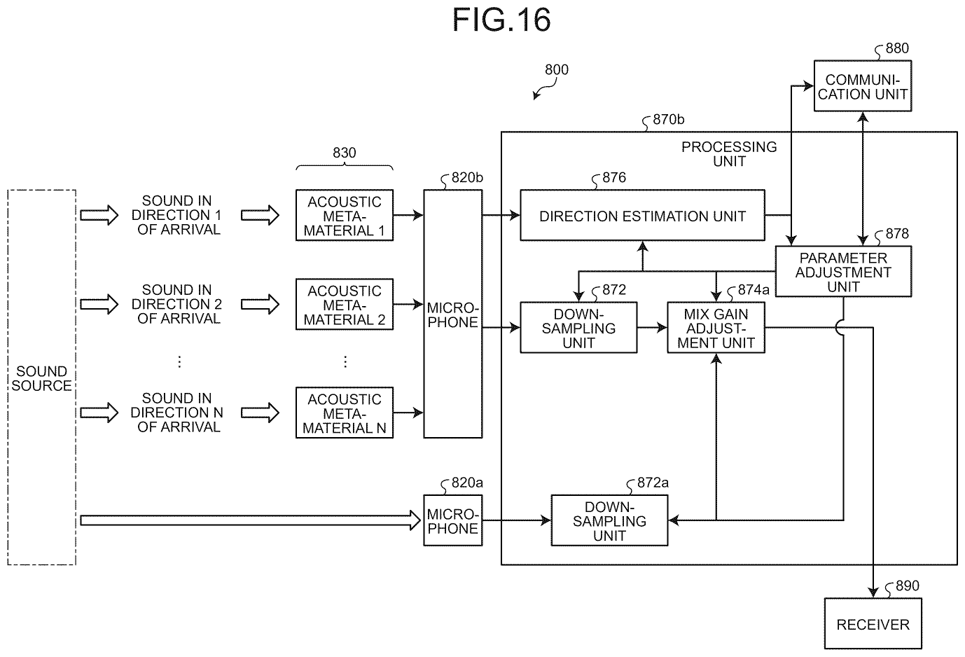

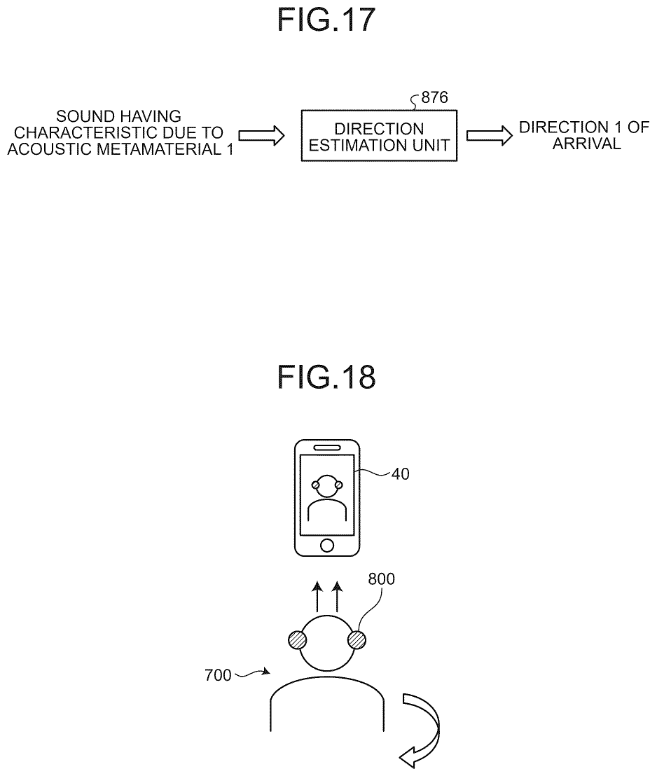

Therefore, a processing unit 870b according to the present embodiment having a function of estimating a direction of arrival will be described with reference to FIGS. 16 and 17. FIG. 16 is a block diagram for explaining functional blocks of the processing unit 870b according to the present embodiment, and FIG. 17 is an explanatory diagram for explaining a direction estimation unit 876 according to the present embodiment.

In the present embodiment, as illustrated in FIG. 16, the processing unit 870b mainly includes a down-sampling unit 872, a down-sampling unit 872a, and a MIX gain adjustment unit 874a, similarly to the above-described first embodiment and modification. The processing unit 870b further includes the direction estimation unit 876 and a parameter adjustment unit 878. Details of each functional unit of the processing unit 870b will be sequentially described below. Here, since the down-sampling units 872 and 872a and the MIX gain adjustment unit 874a are common to the first embodiment and the modification described with reference to FIGS. 14 and 15, the description thereof will be omitted here, and only the direction estimation unit 876 and the parameter adjustment unit 878 will be described.

### (Direction Estimation Unit 876)

The direction estimation unit 876 estimates a direction of arrival of a sound based on a sound acquired by the microphone 820b. Specifically, as illustrated in FIG. 17, the direction estimation unit 876 can estimate the direction of arrival of the sound by searching for, based on a characteristic included in the sound acquired by the microphone 820b, the direction of arrival corresponding to the characteristic using the inverse algorithm. Furthermore, the direction estimation unit 876 transmits the estimation result to an external device such as the information processing terminal 40 via a communication unit 880 (corresponding to the communication unit 27 in FIG. 2). The result of estimating the direction of arrival is displayed (presented) to the user in real time by the information processing terminal 40. The direction estimation unit 876 also outputs the estimation result to the parameter adjustment unit 878 described later. Note that the inverse algorithm can be generated, for example, by machine learning using a data pair including a sound having the above characteristic and the direction of arrival of the sound as teacher data.

### (Parameter Adjustment Unit 878)

The parameter adjustment unit 878 adjusts various parameters to be used for control in the hearing aid 800 based on the estimation result of the direction estimation unit 876 described above, and makes it possible to output a sound that is easily heard by the user, has high reproducibility, and is close to the actual sound around the user. For example, the parameter adjustment unit 878 may adjust a frequency range to be subjected to frequency conversion by the down-sampling units 872 and 872a or a frequency range after the conversion. Moreover, the parameter adjustment unit 878 may adjust a gain in the MIX gain adjustment unit 874a, for example. More specifically, for example, in a case where it is difficult to accurately collect a sound arriving from the back side or the upper side of the user, the parameter adjustment unit 878 adjusts a parameter so that the sound having such a direction of arrival can be emphasized and output to the user. Furthermore, in the present embodiment, the parameter adjustment unit 878 may reduce noise and output a sound that can be easily heard by the user by suppressing a sound from a direction of arrival different from a sound with a large volume based on the result of estimating the direction of arrival of the sound.

Note that the user may input, to the information processing terminal 40, a direction of arrival of a sound that the user feels in response to the presentation of a direction of arrival by the information processing terminal 40. In this way, the information of the difference between the result of estimating the direction of arrival by the direction estimation unit 876 and the direction of arrival felt by the user is accumulated in the information processing server, for example. The accumulated information can be used for an update of the inverse algorithm for estimating the direction of arrival, determination of a user's skill level of estimation of the direction of arrival, determination of an auditory state, diagnosis, adjustment (fitting) of the hearing aid 800, and the like. Further, the above information can also be used for generating an algorithm for adjusting various parameters by the parameter adjustment unit 878 or creating the acoustic metamaterial structure 830 suitable for the user. By using such information, it is possible to adjust parameters and create the acoustic metamaterial structure 830 according to individual characteristics of the user.

In the present embodiment, the processing unit 870b is not limited to the configuration illustrated in FIG. 16.

### 5. Third Embodiment

### 5.1 Training Method 1

As described above, training is required until the user can estimate a direction of arrival of a sound using the hearing aid 800 according to the present embodiment. Therefore, in a third embodiment of the present disclosure, training methods will be described. First, a training method 1 will be described with reference to FIG. 18. FIG. 18 is an explanatory diagram for explaining the training method 1 according to the present embodiment.

An information processing terminal 40 includes an application having a training function and a fitting function. First, a user 700 performs fitting of an inverse algorithm for estimating a direction of arrival and various parameters using the fitting function of the application.

Specifically, as illustrated in FIG. 18, the information processing terminal 40 captures an image of a line of sight and an outer ear (hearing aid 800) of the user 700 wearing a hearing aid 800 with an imaging device (not illustrated) provided in the information processing terminal 40. The information processing terminal 40 detects the orientation of the face of the user 700 in real time, and recognizes the positional relationship between the information processing terminal 40 and the hearing aid 800.

Next, the information processing terminal 40 outputs a predetermined sound for fitting. Then, the hearing aid 800 or the information processing terminal 40 estimates a direction of arrival of a sound based on the sound captured by the hearing aid 800 by the direction estimation unit 876 of the second embodiment described above. Furthermore, the information processing terminal 40 performs fitting of the inverse algorithm by comparing the direction of arrival estimated by the direction estimation unit 876 with a direction of arrival of a sound that can be derived from the recognized positional relationship between the information processing terminal 40 and the hearing aid 800. Next, the user 700 inputs, to the information processing terminal 40, the subjectivity such as the ease of hearing the predetermined sound described above. Then, the information processing terminal 40 adjusts the various parameters used for the control in the hearing aid 800 based on the subjectivity of the user 700 with respect to the recognized positional relationship between the information processing terminal 40 and the hearing aid 800.

Next, the position of the information processing terminal 40 is fixed, and the user 700 turns his/her face and body. Each time, the information processing terminal 40 detects the orientation of the face of the user 700, recognizes the positional relationship between the information processing terminal 40 and the hearing aid 800, and performs output of a predetermined sound, estimation of the direction of arrival of the sound, and fitting of the inverse algorithm. Furthermore, the information processing terminal 40 acquires the subjectivity of the user 700 with respect to the predetermined sound, and adjusts various parameters used for the control in the hearing aid 800 based on the acquired subjectivity.

Note that, in the above description, it has been described that the fitting of the inverse algorithm for estimating a direction of arrival and various parameters is performed by the information processing terminal 40, but the present embodiment is not limited thereto, and the fitting may be performed by the hearing aid 800 or an information processing server on a cloud. In addition, in a case where the function of estimating a direction of arrival of a sound is not used, only the fitting of the various parameters may be performed.

Note that, in the above description, the orientation of the face of the user 700 is detected by capturing an image of the user 700 with the imaging device, and the positional relationship between the information processing terminal 40 and the hearing aid 800 is recognized, but the present embodiment is not limited to such a method. In the present embodiment, for example, a positioning sensor (not illustrated) provided in the hearing aid 800 or the information processing terminal 40 and an IMU provided in the hearing aid 800 may be used to recognize the positional relationship between the information processing terminal 40 and the hearing aid 800.

In the present embodiment, the fitting of the inverse algorithm for estimating a direction of arrival may be performed according to the following method. For example, the hearing aid 800 can be housed in the charger 3 described above. The charger 3 has, for example, a lid, and has a structure (box structure) in which charging can be started by closing the lid. Therefore, when the lid of the charger 3 is closed, the charger 3 can form a closed space. Therefore, a fixing member (not illustrated) that fixes the hearing aid 800 at a predetermined position and a plurality of speakers (not illustrated) whose positions are fixed so as to surround the fixed hearing aid 800 are provided inside the charger 3. Then, in the method, after the hearing aid 800 is fixed inside the charger 3, a predetermined sound for fitting is output from each speaker described above in predetermined order at a timing of closing the lid of the charger 3 as a trigger.

Next, the hearing aid 800 or the information processing terminal 40 estimates a direction of arrival of a sound based on the sound captured by the hearing aid 800 by the direction estimation unit 876 of the second embodiment described above.

Furthermore, since the direction of arrival of the actual sound is known from the position of each speaker, the information processing terminal 40 performs the fitting of the inverse algorithm by comparing the direction of arrival estimated by the direction estimation unit 876 with the direction of arrival of the actual sound. In this method, since the fitting is performed using a sound in the closed space, the fitting can be performed with high accuracy. Furthermore, whether or not a failure of the hearing aid 800 is present may be detected by not only fitting the inverse algorithm for estimating a direction of arrival but also detecting whether or not the hearing aid has caught a predetermined sound from the speakers inside the charger 3 or whether or not the hearing aid 800 has correctly caught a predetermined sound although it has caught a sound. In addition, failure, damage, and mounting failure of the acoustic metamaterial structure 830 can be similarly detected.

Next, the user 700 performs training for estimating a direction of arrival of a sound using the training function of the application. Next, the position of the information processing terminal 40 is fixed, and the user 700 wearing the hearing aid 800 turns his/her face and body. Each time, the information processing terminal 40 outputs a predetermined sound for training. While being conscious of the position of the information processing terminal 40, the user 700 learns characteristics of sounds for each of directions of arrival of sounds by hearing the sounds having characteristics corresponding to the directions of arrival due to the acoustic metamaterial structure 830 via the hearing aid 800. By repeatedly performing such training, the user 700 acquires a skill of estimating a direction of arrival of a sound based on heard sounds using the plasticity of the human brain.

### 5.2 Training Method 2

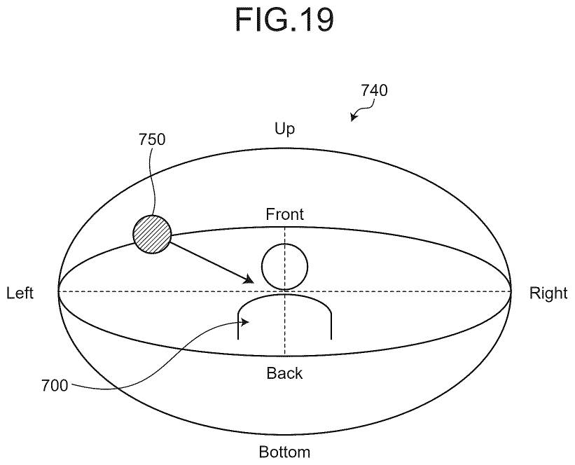

In the training method 1 described above, the predetermined sound is output from the information processing terminal 40, but the training method according to the present embodiment is not limited to such a dedicated sound, and training may be performed using a sound that can be heard in daily life. Therefore, a method of performing such training using sound around the user 700 will be described with reference to FIG. 19. FIG. 19 is an explanatory diagram for explaining a training method 2 according to the present embodiment.

In the training method 2, the user 700 is trained by actively using a result of estimating a direction of arrival of a sound by the direction estimation unit 876 of the second embodiment described above. Specifically, in the hearing aid 800 or the information processing terminal 40 worn by the user 700, the direction estimation unit 876 estimates a direction of arrival of a sound based on the sound captured by the hearing aid 800. Then, a display device (not illustrated) such as the information processing terminal 40, a television, or a projector performs display for indicating the estimated direction of arrival based on the estimation result. In the present embodiment, for example, a direction of arrival of a sound with reference to the user 700 is presented by a marker 750 on a graphical user interface (GUI) 740 as illustrated in FIG. 19. While being conscious of the direction of arrival indicated by the GUI, the user 700 listens to the sound having the characteristic according to the direction of arrival due to the acoustic metamaterial structure 830 through the hearing aid 800, thereby learning a characteristic of each direction of arrival of a sound. By repeatedly performing such training, the user 700 acquires a skill of estimating a direction of arrival of a sound based on heard sounds using the plasticity of the human brain.

Note that the training fitting according to the present embodiment is not limited to the above-described example.

### 6. Summary

As described above, in the embodiment of the present disclosure, the acoustic metamaterial structure 830 attached to the hearing aid 800 gives a predetermined characteristic to a sound according to a direction of arrival of the sound, and the user 700 can recognize the direction of arrival of the sound by using the sound having the predetermined characteristic. The acoustic metamaterial structure 830 has a very small size according to the wavelength of sound acting thereon, so that even the small hearing aid 800 can be mounted. Then, in the present embodiment, the single microphone 820b can acquire a plurality of sounds having different frequency characteristics given by the acoustic metamaterial structure 830. Therefore, according to the present embodiment, since it is not necessary to provide a plurality of microphones for each direction of arrival of a sound, the hearing aid 800 can be reduced in size. Furthermore, in the present embodiment, the hearing aid 800 can cause the user 700 to recognize a direction of arrival of a sound by cooperating with the ability to estimate a direction of arrival of a sound obtained by the training of the user 700. Therefore, according to the present embodiment, since it is not necessary to provide a special device that estimates a direction of arrival of a sound and presents the result thereof to the user 700, the hearing aid 800 can have a simple configuration.

The present embodiment can be used not only for a person with hearing loss but also for a healthy person to further improve the ability to estimate a direction of arrival of a sound. For example, in e-sports or a metaverse space, in a case where the user 700 arbitrarily moves in a virtual world/space from the viewpoint of the user, like a first-person shooter (FPS), a clue based on a sound is important. In particular, it is difficult for even a healthy person to recognize a sound from behind or above or a sound having a high frequency, and the resolution of the direction of arrival of the sound is also lower than that of an animal such as a cat or a dog. Therefore, by using the present embodiment, the user 700 can quickly recognize a sound from behind or from above, and can recognize the direction of arrival of the sound with high resolution.

Note that, in the description of the embodiment of the present disclosure described above, the case where the present disclosure is applied to the hearing aid 800 has been described as an example, but the embodiment of the present disclosure can also be applied to other auditory devices (for example, earphones, headphones, sound collectors, and the like).

### 7. Variation of Hearing Aid System

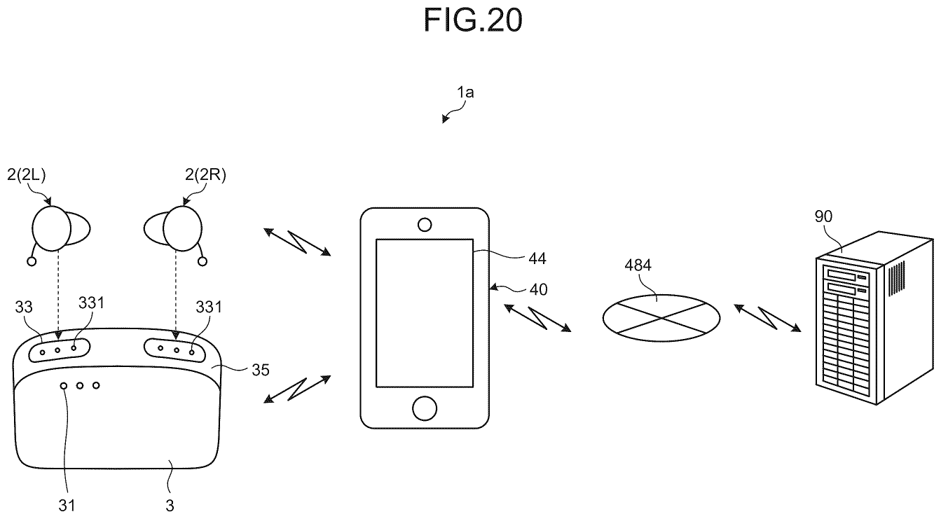

The hearing aid system 1 may include an information processing server. Therefore, a hearing aid system la according to a modification of the present embodiment will be described with reference to FIG. 20. FIG. 20 is a diagram illustrating a schematic configuration of the hearing aid system la according to the modification of the present embodiment.

As illustrated in FIG. 20, the hearing aid system la according to the present modification includes a hearing aid 2, a charger 3 that houses the hearing aid 2 and charges the hearing aid 2, and an information processing terminal 40 including a smartphone or the like capable of communicating with at least one of the hearing aid 2 and the charger 3. Further, the hearing aid system la includes a server (information processing server) 90 managed by a sales company, a support service providing company, or the like of the hearing aid 800.

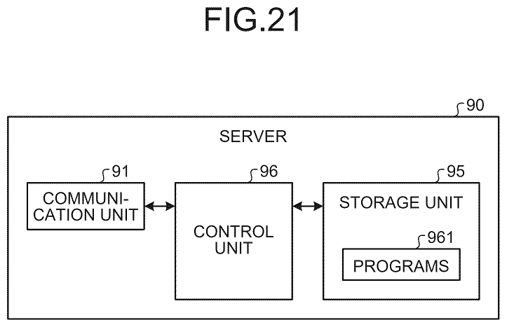

Then, the server 90 may be configured as illustrated in FIG. 21. FIG. 21 is a block diagram of the server 90 according to the present modification. As illustrated in FIG. 21, the server 90 mainly includes a communication unit 91, a storage unit 95, and a control unit 96.

The communication unit 91 communicates with the hearing aid 2 and the information processing terminal 40 via a communication network 484 under the control of the control unit 96. The communication unit 91 can be configured using, for example, a communication module. Furthermore, the storage unit 95 stores various types of information regarding the hearing aid 500. Furthermore, the storage unit 95 stores various programs 961 and the like executed by the server 90. The storage unit 95 can be configured using, for example, a recording medium such as a RAM, a ROM, a flash memory, or a memory card.

The control unit 96 controls each of the units constituting the server 90. The control unit 96 can be configured using, for example, a memory and a processor having hardware such as a CPU. The control unit 96 reads the programs stored in the storage unit 95 into a work area of the memory and executes the programs to control each of the units and the like through the execution of the programs by the processor.

### 8. Example of Use of Data

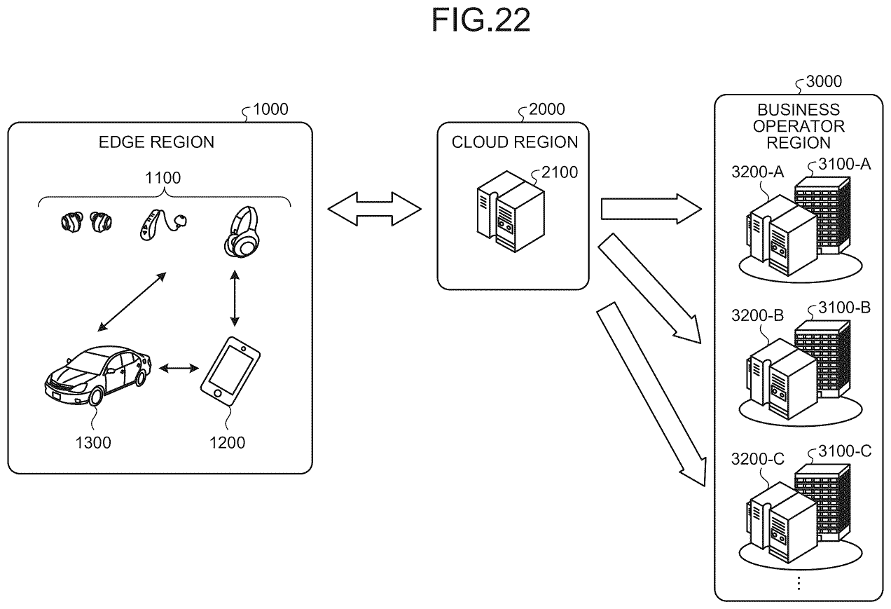

Furthermore, data obtained in relation to use of the hearing aid 800 according to the embodiment of the present disclosure may be used in various ways. An example thereof will be described with reference to FIG. 22.

FIG. 22 is a diagram illustrating an example of use of data. In a system illustrated, an edge region 1000, a cloud region 2000, and a business operator region 3000 are present. As elements in the edge region 1000, a sound producing device 1100, a peripheral device 1200, and a vehicle 1300 are exemplified. As an element in the cloud region 2000, a server device 2100 is exemplified. As elements in the business operator region 3000, a business operator 3100 and a server device 3200 are exemplified.

The sound producing device 1100 in the edge region 1000 is used while being worn by the user or arranged near the user so as to emit a sound toward the user. Specific examples of the sound producing device 1100 include earphones, a headset (headphone), a hearing aid, and a sound collector. More specifically, the sound producing device 1100 can be the hearing aid 800 according to the embodiment of the present disclosure.

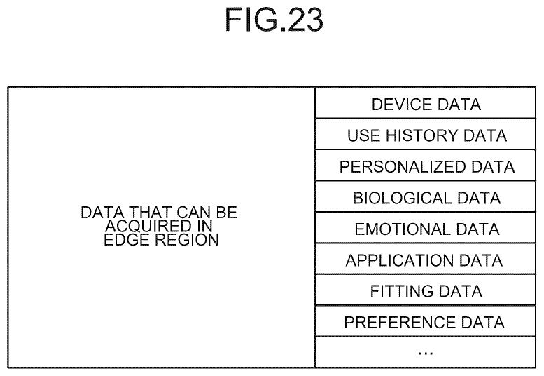

The peripheral device 1200 and the vehicle 1300 in the edge region 1000 are devices used together with the sound producing device 1100, and transmit signals such as a content listening sound, a call sound, and a warning sound to the sound producing device 1100, for example. The sound producing device 1100 outputs a sound corresponding to a signal from the peripheral device 1200 or the vehicle 1300 to the user. A specific example of the peripheral device 1200 is a smartphone or the like. For example, the information processing terminal 40 described above with reference to FIG. 1 may be used as the peripheral device In the edge region 1000, various data regarding use of the sound producing device 1100 can be acquired. A description will be given with reference to FIG. 23.

FIG. 23 is a diagram illustrating an example of data. As data that can be acquired in the edge region 1000, device data, use history data, personalized data, biological data, emotional data, application data, fitting data, and preference data are exemplified. Note that the data may be understood as meaning of information, and they may be appropriately replaced with each other as long as there is no contradiction. Various known methods may be used to acquire the exemplified data.

The device data is data regarding the sound producing device 1100, and includes, for example, type data of the sound producing device 1100, specifically, data identifying that the sound producing device 1100 is an earphone, a headphone, a true wireless stereo (TWS), a hearing aid (CIC, ITE, RIC, or the like), or the like.

The use history data is use history data of the sound producing device 1100, and includes, for example, data such as a music exposure dose, a continuous use time of the hearing aid, and a content listening history (a listening time and the like). The use history data can be used for safe listening, hearing aid adaptation of a TWS, a notification of replacement of an earwax intrusion preventing filter (not illustrated) provided in the hearing aid 800, and the like.

The personalized data is data regarding the user of the sound producing device 1100, and includes, for example, a head related transfer function (HRTF), an ear canal characteristic, a type of cerumen, and the like of the individual user. Furthermore, data such as hearing may also be included in the personalized data.

The biological data is biological data of the user of the sound producing device 1100, and includes, for example, data such as the perspiration, blood pressure, blood flow, heart rate, pulse, body temperature, brain wave, respiration, and myoelectric potential.

The emotion data is data indicating the emotion of the user of the sound producing device 1100, and includes, for example, data indicating comfort, discomfort, or the like.

The application data is data used in various applications, and includes, for example, user attribute information data such as the position (or the position of the sound producing device 1100), schedule, age, gender, and the like of the user of the sound producing device 1100, and data such as weather, atmospheric pressure, temperature, and the like. For example, the position data can be used to search for the sound producing device 1100 or to determine a timing to predict clogging of the above-described earwax intrusion preventing filter.

The fitting data can include, for example, adjustment parameters of the hearing aid 2 used by the user, a hearing aid gain for each frequency band set based on a hearing measurement result (audiogram) of the user, and the like.

The preference data is data regarding the preference of the user, and includes, for example, data such as the preference of music to listen to while driving.

Note that data of a communication status, data of a charging status of the sound producing device 1100 and the like may also be acquired. A part of the processing in the edge region 1000 may be executed by the cloud region 2000 according to the band, the communication status, the charging status, and the like. By sharing the processing, the processing load in the edge region 1000 is reduced.

Returning to FIG. 22, for example, data as described above is acquired in the edge region 1000 and transmitted from the sound producing device 1100, the peripheral device 1200, or the vehicle 1300 to the server device 2100 in the cloud region 2000. The server device 2100 stores (storage, accumulation, etc.) the received data.

The business operator 3100 in the business operator region 3000 uses the server device 3200 to acquire data from the server device 2100 in the cloud region 2000. The data can be used by the business operator 3100.

Different business operators 3100 may be present. Specific examples of the business operator 3100 are a hearing aid store, a hearing aid manufacturer, a content production company, a distribution business operator providing a music streaming service, and the like, which are referred to as a business operator 3100-A, a business operator 3100-B, and a business operator 3100-C so as to distinguish them in the drawing. Corresponding server devices 3200 are referred to as a server device 3200-A, a server device 3200-B, and a server device 3200-C in the drawing. Various data are provided to such various business operators 3100, and use of the data is promoted. The data provision to the business operators 3100 may be, for example, data provision by subscription, recall, or the like.

Data can also be provided from the cloud region 2000 to the edge region 1000. For example, in a case where machine learning is required to implement processing in the edge region 1000, data for feedback, correction, and the like of learning data is prepared by an administrator or the like of the server device 2100 in the cloud region 2000. The prepared data is transmitted from the server device 2100 to the sound producing device 1100, the peripheral device 1200, or the vehicle 1300 in the edge region 1000.

In a case where a specific condition is satisfied in the edge region 1000, some incentive (benefit such as a premium service) may be provided to the user. An example of the condition is a condition that at least some devices of the sound producing device 1100, the peripheral device 1200, and the vehicle 1300 are devices provided by the same business operator. In a case of an incentive (electronic coupon or the like) that can be electronically supplied, the incentive may be transmitted from the server device 2100 to the sound producing device 1100, the peripheral device 1200, or the vehicle 1300.

### 9. Example of Cooperation with Another Device

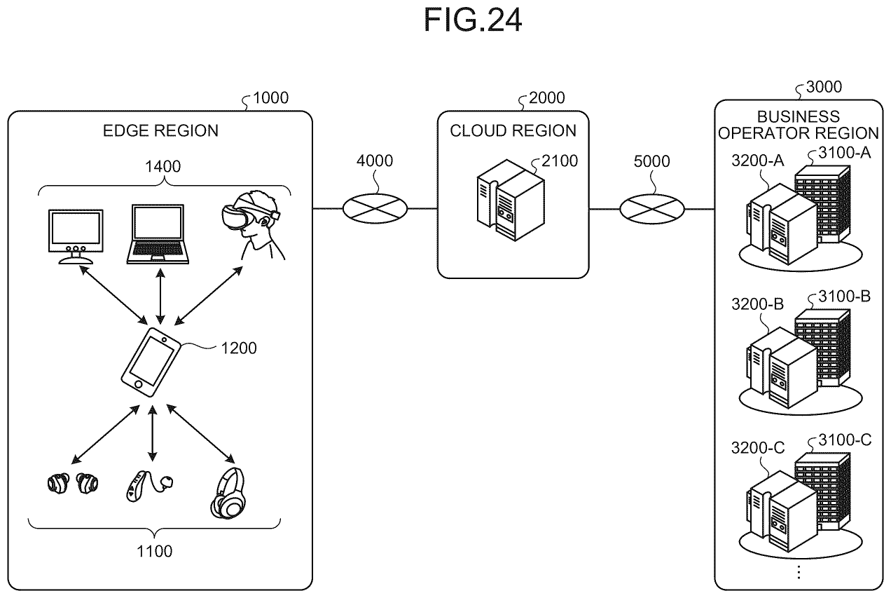

In the edge region 1000, for example, the sound producing device 1100 may cooperate with another device using the peripheral device 1200 such as a smartphone as a hub. An example thereof will be described with reference to FIG. 24.

FIG. 24 is a diagram illustrating an example of cooperation with another device. The edge region 1000, the cloud region 2000, and the business operator region 3000 are connected by a network 4000 and a network 5000. A smartphone is exemplified as the peripheral device 1200 in the edge region 1000, and another device 1400 is also exemplified as an element in the edge region 1000. Note that illustration of the vehicle 1300 (FIG. 22) is omitted.

The peripheral device 1200 can communicate with each of the sound producing device 1100 and the other device 1400. The communication method is not particularly limited, but for example, LDAC, Bluetooth LE Audio described above, or the like may be used. Communication between the peripheral device 1200 and the other device 1400 may be multicast communication. An example of the multicast communication is Auracast (registered trademark) or the like.

The other device 1400 is used in cooperation with the sound producing device 1100 via the peripheral device 1200. Specific examples of the other device 1400 include a television (hereinafter, referred to as a television), a personal computer (PC), a head mounted display (HMD), a robot, a smart speaker, a gaming device, and the like.

Even in a case where the sound producing device 1100, the peripheral device 1200, and the other device 1400 satisfy a specific condition (for example, a condition that at least a part thereof is provided by the same business operator), an incentive may be provided to the user.

The sound producing device 1100 and the other device 1400 can cooperate with each other using the peripheral device 1200 as a hub. The cooperation may be performed using various data stored in the server device 2100 in the cloud region 2000. For example, information such as fitting data, listening time, and hearing of the user is shared between the sound producing device 1100 and the other device 1400, whereby volume adjustment and the like of each device are performed in cooperation. Setting for the hearing aid 2 or a PSAP can be automatically performed on a television, a PC, or the like when the hearing aid 800 (HA) or the sound collector (personal sound amplification product (PSAP)) is worn. For example, when the user using the hearing aid 800 uses another device such as a television or a PC, processing of automatically changing the setting of the other device may be performed so that a normal setting for a person with normal hearing changes to a setting suitable for the user using the hearing aid. Note that whether or not the user is using the hearing aid 800 may be determined by automatically sending information indicating that the user has worn the hearing aid 800 (for example, wearing detection information) to a device such as a television, a PC, or the like as a pairing destination of the hearing aid 800 when the user wears the hearing aid 800, or may be detected by using an approach of the user using the hearing aid to another device such as a target television, a PC, or the like as a trigger. Furthermore, it may be determined that the user is a hearing aid user by imaging the face of the user with a camera or the like provided in another device such as a television, a PC, or the like, or may be determined that the user is a hearing aid user by a method other than the above-described method. Furthermore, for example, the hearing aid 800, which is the sound producing device 1100, and the other device 1400 cooperate with each other, so that the hearing aid 800 can function as an earphone. Furthermore, when the other device 1400 includes a microphone that collects ambient sound, an earphone that serves as the sound producing device 1100 can function like the hearing aid 800. In this case, a function of the hearing aid can be used in a style (appearance or the like) as if listening to music. The earphone/headphone and the hearing aid have many technically overlapping parts, and it is assumed that the barrier between the earphone/headphone and the hearing aid will disappear in the future, and one device will have functions of both the earphone and the hearing aid.

When the hearing is normal, that is, a person with normal hearing can enjoy content listening experience by using it as normal earphones/headphone, and when the hearing is lowered due to aging or the like, it can function as a hearing aid by turning on the hearing aid function. Since the device as an earphone can be used as it is as a hearing aid, continuous and long-term use by the user can be expected also from the viewpoint of appearance and design.

Data of listening histories of the user may be shared. Prolonged listening can be a risk for future hearing loss. Notification or the like to the user may be performed so that the listening time does not become too long. For example, when the listening time exceeds a predetermined threshold value, such a notification is performed (safe listening). The notification may be performed by any device in the edge region 1000.

At least a part of the devices used in the edge region 1000 may be provided by a different business operator. Information regarding device settings and the like of each business operator may be transmitted from the server device 3200 in the business operator region 3000 to the server device 2100 in the cloud region 2000 and stored in the server device 2100. By using such information, it is also possible to cooperate between devices provided by different business operators.

### 10. Example of Changes of Use

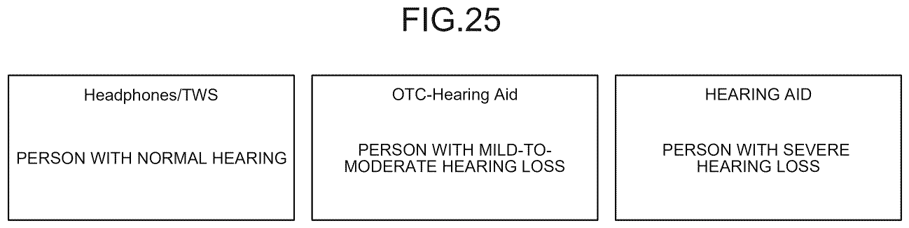

The use of the sound producing device 1100 may change according to various situations including the fitting data, the listening time, the hearing ability, and the like of the user as described above. An example will be described with reference to FIG. 25.

FIG. 25 is a diagram illustrating an example of changes of use. When the user is a person with normal hearing, for example, while the user is a child and for a while after the user becomes an adult, the sound producing device 1100 is used as a headphone or earphones (headphones/TWS). In addition to the safe listening described above, adjustment of an equalizer, processing (for example, a noise canceling mode is switched to an optimal noise canceling mode for a scene in which the user is at a restaurant and a scene in which the user is on a vehicle) according to a behavior characteristic and current location of the user, and external environment, collection of a listening music log, and the like are performed. Communication between devices using Auracast is also used.

As the user's hearing decreases, a hearing aid function of the sound producing device 1100 starts to be used. For example, while the user has mild-to-moderate hearing loss, the sound producing device 1100 is used as an over the counter hearing aid (OTC hearing aid). When the user has severe hearing loss, the sound producing device 1100 is used as a hearing aid. Note that the OTC hearing aid is a hearing aid that is sold at a store without an expert, and can be purchased without a hearing test and an expert such as an audiologist. A specific operation of the hearing aid, such as fitting, may be performed by the user himself/herself. While the sound producing device 1100 is used as an OCT hearing aid or a hearing aid, hearing measurement is performed or the hearing aid function is turned on. For example, a function such as transmission of an utterance flag in the above-described embodiment can also be used. In addition, various types of information regarding hearing (hearing big data) are collected, fitting, sound environment adaptation, remote support, and the like are performed, and a transcription is performed.

### 11. Supplement

Although the preferred embodiments of the present disclosure have been described in detail with reference to the accompanying drawings, the technical scope of the present disclosure is not limited to the examples. It is obvious that a person having ordinary knowledge in the technical field of the present disclosure can conceive various changes or modifications within the scope of the technical idea described in the claims, and it is naturally understood that these also belong to the technical scope of the present disclosure.

Furthermore, the effects described in the present specification are merely illustrative or exemplary, and are not restrictive.

That is, the technology according to the present disclosure can exhibit other effects obvious to those skilled in the art from the description of the present specification together with or instead of the above effects.

Note that the present technology can also include the following configurations.
(1) A sound processing device comprising:
   a first sound collection unit configured to acquire a sound;
   an acoustic metamaterial attached to the first sound collection unit; and
   an output unit configured to output the sound acquired by the first sound collection unit, wherein
   the acoustic metamaterial gives a predetermined characteristic to the sound according to a direction of arrival of the sound, and
   the first sound collection unit acquires the sound having the predetermined characteristic.
(2) The sound processing device according to (1), wherein the acoustic metamaterial is configured to provide the sound with at least one of different frequency characteristics, different wavelengths, and different amplitudes for each direction of arrival.
(3) The sound processing device according to (1) or (2), wherein the first sound collection unit acquires a plurality of sounds that have arrived in different directions of arrival.
(4) The sound processing device according to any one of (1) to (3), further comprising
   the plurality of first sound collection units, wherein the acoustic metamaterial is provided in at least one of the first sound collection units.
(5) The sound processing device according to any one of (1) to (4), wherein
   the acoustic metamaterial has a plurality of opening portions provided for the respective directions of arrival, and
   the opening portions are provided with resonating bodies having the same structure or size.
(6) The sound processing device according to any one of (1) to (4), wherein
   the acoustic metamaterial has a plurality of opening portions provided for the respective directions of arrival, and
   the opening portions are provided with resonating bodies having different structures or sizes.
(7) The sound processing device according to (5) or (6), wherein the resonating bodies include Helmholtz resonators, side branch resonance tube, or membrane resonators.
(8) The sound processing device according to any one of (1) to (7), wherein at least a part of the sound processing device is configured to be attachable to an inside of an ear canal of a user.
(9) The sound processing device according to (8), wherein the first sound collection unit is located outside the ear canal of the user.
(10) The sound processing device according to any one of (1) to (9), further comprising a converter configured to convert a component having a first frequency included in the sound acquired by the first sound collection unit into a component having a second frequency according to an auditory characteristic of a user, and output the converted component to the output unit.
(11) The sound processing device according to (10), wherein the first frequency is higher than the second frequency.
(12) The sound processing device according to (10) or (11), further comprising an amplification unit configured to amplify the sound acquired by the first sound collection unit with a gain corresponding to the user and output the amplified sound to the output unit.
(13) The sound processing device according to (12), further comprising
   a second sound collection unit configured to acquire a sound around the user without using the acoustic metamaterial,
   the output unit outputs the sound acquired by the second sound collection unit together with the sound acquired by the first sound collection unit.
(14) The sound processing device according to (13), wherein the amplification unit amplifies the sound acquired by the second sound collection unit with a gain according to the auditory characteristic of the user.
(15) The sound processing device according to any one of (1) to (14), further comprising
   an estimation unit configured to estimate the direction of arrival of the sound based on a characteristic of the sound acquired by the first sound collection unit.
(16) The sound processing device according to (15), further comprising a parameter adjustment unit configured to adjust various parameters used for control in the sound processing device based on a result of the estimation by the estimation unit.
(17) The sound processing device according to any one of (1) to (16), wherein the sound processing device is at least one of an earphone, a headphone, a hearing aid, and a sound collector.
(18) The sound processing device according to any one of (1) to (17), wherein the acoustic metamaterial is attachable and detachable.
(19) A sound processing system comprising:
   a sound processing device; and
   an information processing terminal used by a user, wherein
   the sound processing device and the information processing terminal can communicate with each other, and
   the sound processing device includes:
   a first sound collection unit configured to acquire a sound;
   an acoustic metamaterial attached to the first sound collection unit; and
   an output unit configured to output the sound acquired by the first sound collection unit,
   the acoustic metamaterial gives a predetermined characteristic to the sound according to a direction of arrival of the sound, and
   the first sound collection unit acquires the sound having the predetermined characteristic.
(20) The sound processing system according to (19), wherein
   the sound processing device or the information processing terminal includes an estimation unit configured to estimate the direction of arrival of the sound based on a characteristic of the sound acquired by the first sound collection unit, and
   a result of the estimation by the estimation unit is presented to the user by the information processing terminal.

### REFERENCE SIGNS LIST

1, 1a Hearing aid system
2, 100, 500, 600, 800 Hearing aid
3 Charger
20, 20b, 20f Sound collection unit
21 Signal processing unit
22, 43 Output unit
25, 32 Battery
26, 331 Connection unit
27, 30, 34, 42, 91 Communication unit
28, 35, 45, 95 Storage unit
29, 36, 46, 96 Control unit
31, 44 Display unit
33 Housing unit
40 Information processing terminal
41 Input unit
90 Server
101, 222, 501, 890 Receiver
102, 502 Earwax intrusion preventing filter
103 Ear tip
104, 201, 504, 612A, 612B, 820a, 820b Microphone
107, 108, 507, 508 Hole
202 A/D converter
221 D/A converter
281, 351, 451, 961 Program
282 Data
509 Gut
615A, 615B Speaker
700 User
740 GUI
750 Marker
791 Outer side of ear canal
792 Inner side of ear canal
810 Housing
830 Acoustic metamaterial structure
832a, 832b, 832c Opening
834 Helmholtz resonator
840 Side branch resonance tube
850 Membrane resonator
836 Inlet
838 Outlet
852 Membrane
854 Weight
870, 870a, 870b Processing unit
872, 872a Down-sampling unit
874, 874a MIX gain adjustment unit
876 Direction estimation unit
878 Parameter adjustment unit

1. A sound processing device comprising:
a first sound collection unit configured to acquire a sound;
an acoustic metamaterial attached to the first sound collection unit; and
an output unit configured to output the sound acquired by the first sound collection unit, wherein
the acoustic metamaterial gives a predetermined characteristic to the sound according to a direction of arrival of the sound, and
the first sound collection unit acquires the sound having the predetermined characteristic.

2. The sound processing device according to claim 1, wherein the acoustic metamaterial is configured to provide the sound with at least one of different frequency characteristics, different wavelengths, and different amplitudes for each direction of arrival.

3. The sound processing device according to claim 1, wherein the first sound collection unit acquires a plurality of sounds that have arrived in different directions of arrival.

4. The sound processing device according to claim 1, further comprising
the plurality of first sound collection units, wherein the acoustic metamaterial is provided in at least one of the first sound collection units.

5. The sound processing device according to claim 1, wherein
the acoustic metamaterial has a plurality of opening portions provided for the respective directions of arrival, and
the opening portions are provided with resonating bodies having the same structure or size.

6. The sound processing device according to claim 1, wherein
the acoustic metamaterial has a plurality of opening portions provided for the respective directions of arrival, and
the opening portions are provided with resonating bodies having different structures or sizes.

7. The sound processing device according to claim 5, wherein the resonating bodies include Helmholtz resonators, side branch resonance tube, or membrane resonators.

8. The sound processing device according to claim 1, wherein at least a part of the sound processing device is configured to be attachable to an inside of an ear canal of a user.

9. The sound processing device according to claim 8, wherein the first sound collection unit is located outside the ear canal of the user.

10. The sound processing device according to claim 1, further comprising a converter configured to convert a component having a first frequency included in the sound acquired by the first sound collection unit into a component having a second frequency according to an auditory characteristic of a user, and output the converted component to the output unit.

11. The sound processing device according to claim 10, wherein the first frequency is higher than the second frequency.

12. The sound processing device according to claim 10, further comprising an amplification unit configured to amplify the sound acquired by the first sound collection unit with a gain corresponding to the user and output the amplified sound to the output unit.

13. The sound processing device according to claim 12, further comprising
a second sound collection unit configured to acquire a sound around the user without using the acoustic metamaterial,
the output unit outputs the sound acquired by the second sound collection unit together with the sound acquired by the first sound collection unit.

14. The sound processing device according to claim 13, wherein the amplification unit amplifies the sound acquired by the second sound collection unit with a gain according to the auditory characteristic of the user.

15. The sound processing device according to claim 1, further comprising
an estimation unit configured to estimate the direction of arrival of the sound based on a characteristic of the sound acquired by the first sound collection unit.

16. The sound processing device according to claim 15, further comprising a parameter adjustment unit configured to adjust various parameters used for control in the sound processing device based on a result of the estimation by the estimation unit.

17. The sound processing device according to claim 1, wherein the sound processing device is at least one of an earphone, a headphone, a hearing aid, and a sound collector.

18. The sound processing device according to claim 1, wherein the acoustic metamaterial is attachable and detachable.

19. A sound processing system comprising:
a sound processing device; and
an information processing terminal used by a user, wherein
the sound processing device and the information processing terminal can communicate with each other, and
the sound processing device includes:
a first sound collection unit configured to acquire a sound;
an acoustic metamaterial attached to the first sound collection unit; and
an output unit configured to output the sound acquired by the first sound collection unit,
the acoustic metamaterial gives a predetermined characteristic to the sound according to a direction of arrival of the sound, and
the first sound collection unit acquires the sound having the predetermined characteristic.

20. The sound processing system according to claim 19, wherein
the sound processing device or the information processing terminal includes an estimation unit configured to estimate the direction of arrival of the sound based on a characteristic of the sound acquired by the first sound collection unit, and
a result of the estimation by the estimation unit is presented to the user by the information processing terminal.
